(19) United States
(12) Patent Application Publication
(10) Pub. No.: US 2024/0269700 A1
(43) Pub. Date: Aug. 15, 2024

(54) SPRAY GUN AND COMPONENTS FOR SPRAYING PAINTS AND OTHER COATINGS

(71) Applicant: Graco Minnesota Inc., Minneapolis, MN (US)

(72) Inventors: Augustine T. Sierra, II, Plymouth, MN (US); Ryan F. Butler, Champlin, MN (US); Joseph E. Tix, Hastings, MN (US)

(21) Appl. No.: 18/568,535

(22) PCT Filed: Jun. 10, 2022
(86) PCT No.: PCT/US2022/033006

§ 371 Date: Dec. 8, 2023

Related U.S. Application Data
(60) Provisional application No. 63/209,070, filed on Jun. 10, 2021.

(51) Int. Cl. B05B 12/00; B05B 7/12; B05B 7/24; B05B 9/01

(52) U.S. Cl. CPC B05B 12/0026; B05B 7/1209; B05B 7/2408; B05B 9/01

(57) ABSTRACT

A spray gun includes a valve cartridge configured to be axially installed and removed as a single piece. The valve cartridge includes at least one engagement member to prevent rotation of valve cartridge within the gun body of the spray gun.

### CROSS-REFERENCE TO RELATED APPLICATION(S)

This application claims priority to U.S. Provisional Application No. 63/209,070 filed Jun. 10, 2021 and entitled “SPRAY GUN AND COMPONENTS FOR SPRAYING PAINTS AND OTHER COATINGS,” the disclosure of which is hereby incorporated by reference in its entirety.

### BACKGROUND

This disclosure relates generally to sprayers. More specifically, this disclosure relates to spray guns for sprayers.

Spray guns can be used to spray fluids on surfaces. For example, spray guns can be used to spray paint, lacquer, finishes, epoxies, and other coatings on walls, ceilings, and other structures and/or surfaces. While various fluids can be sprayed by the embodiments referenced herein, paint will be used herein as an example.

Typically, the paint is placed under pressure by a piston, diaphragm, or other positive displacement pump. The pump can place the paint under pressure between 500 to 7,500 pounds per square inch (psi), although higher and lower pressures are possible. The pump outputs the paint under pressure through a flexible hose. A spray gun is used to dispense the paint, the gun being attached to the end of the hose opposite the pump. In this way, the spray gun does not include a pump, but rather releases paint pumped to the spray gun through the hose. The spray gun atomizes the paint under pressure into a spray fan, which is applied to a surface. The pump and mechanical and/or electrical systems which operate the pump are typically stationary while the user moves the gun and hose around to spray various surfaces.

Paint and other coatings can be abrasive, and can wear on the spray gun and other components of the spray system. Spray guns typically require maintenance over time, which involves replacement of components worn down by use, particularly those components that move while handling the flow of paint under high fluid pressure. Ideally, users are able to service and repair the spray gun in the field to minimize disruption to their present project. A spray gun having enhanced field serviceability is disclosed herein. Other spray gun features are disclosed herein as well.

### SUMMARY

According to an aspect of the disclosure, a paint spray gun includes a gun body; a valve cartridge removably secured to the gun body; and a trigger attached to the gun body and structured to actuate the valve cartridge. The gun body interfaces with the valve cartridge at an anti-rotation interface that prevents rotation of the valve cartridge when attached to the gun body.

According to an additional or alternative aspect of the disclosure, a paint spray gun includes a gun body having a gun bore formed therein; and a valve cartridge mountable to and dismountable from the gun body, the valve cartridge configured to connect to a hose supplying spray fluid to the paint spray gun, the valve cartridge including a valve within the valve cartridge, the valve configured to be actuated between an open state and a closed state. The valve cartridge is at least partially disposed within the gun body. A fluid inlet of the valve cartridge is disposed outside of the gun body with the valve cartridge mounted to the gun body.

According to another additional or alternative aspect of the disclosure, a valve cartridge for a paint spray gun includes a cartridge body and a valve disposed within the cartridge body. The cartridge body includes an outlet end having a cartridge outlet therethrough; a mount end; and a fluid inlet extending through the cartridge body from an exterior of the cartridge body to a fluid chamber formed within the cartridge body, the fluid inlet disposed between the outlet end and the mount end. The valve is configured to control flow of the paint from the fluid chamber through the cartridge outlet.

According to yet another additional or alternative aspect of the disclosure, a valve cartridge for a paint spray gun includes a cartridge body, a valve, and a needle. The cartridge body includes an outlet end having a cartridge outlet therethrough; a mount end; and a fluid inlet extending through the cartridge body from an exterior of the cartridge body to a fluid chamber formed within the cartridge body, the fluid inlet disposed between the outlet end and the mount end. The valve is disposed within the cartridge body and configured to control flow of the paint from the fluid chamber through the cartridge outlet. The needle is partially disposed within the cartridge body and extending out of the cartridge body through the mount end, the needle movable along a valve axis to actuate the valve between an open state and a closed state.

According to yet another additional or alternative aspect of the disclosure, a valve cartridge for a paint spray gun includes a cartridge body, a valve, and a needle. The cartridge body includes an outlet end having a cartridge outlet therethrough; a mount end; and a fluid inlet extending through the cartridge body from an exterior of the cartridge body to a fluid chamber formed within the cartridge body, the fluid inlet disposed between the outlet end and the mount end. The valve is disposed within the cartridge body and configured to control flow of the paint from the fluid chamber through the cartridge outlet. The needle is partially disposed within the cartridge body and extending out of the cartridge body through the mount end, the needle movable along a valve axis to actuate the valve between an open state and a closed state. An inlet fitting connected to the cartridge body and projecting radially outward relative to the valve axis.

According to yet another additional or alternative aspect of the disclosure, a valve cartridge for a paint spray gun includes a cartridge body, a valve, and a needle. The cartridge body includes an outlet end having a cartridge outlet therethrough; a mount end; a body housing; a diffuser housing mounted to a first end of the body housing; a packing nut mounted to a second end of the body housing opposite the first end; and a fluid inlet extending through the cartridge body from an exterior of the cartridge body to a fluid chamber formed within the cartridge body, the fluid inlet disposed between the outlet end and the mount end. The valve is disposed within the cartridge body and configured to control flow of the paint from the fluid chamber through the cartridge outlet. The needle is partially disposed within the cartridge body and extending out of the cartridge body through the mount end, the needle movable along a valve axis to actuate the valve between an open state and a closed state. An inlet fitting is connected to the cartridge body and projecting radially outward relative to the valve axis.

According to yet another additional or alternative aspect of the disclosure, a valve cartridge for a paint spray gun includes a cartridge body, a valve, and a needle. The cartridge body includes an outlet end having a cartridge outlet therethrough; a mount end; a fluid inlet extending through the cartridge body from an exterior of the cartridge body to a fluid chamber formed within the cartridge body, the fluid inlet disposed between the outlet end and the mount end; a cartridge lock shaped to interface with a gun body of the paint spray gun to prevent rotation of the of the cartridge body about the valve axis and relative to the gun body; a mount lock shaped to interface with an axial retainer to prevent axial displacement of the cartridge body relative to the gun body; and a tip lock shaped to interface with an axial retainer to prevent axial displacement of a spray tip relative to the valve cartridge. The valve is disposed within the cartridge body and configured to control flow of the paint from the fluid chamber through the cartridge outlet. The needle is partially disposed within the cartridge body and extending out of the cartridge body through the mount end, the needle movable along a valve axis to actuate the valve between an open state and a closed state.

According to yet another additional or alternative aspect of the disclosure, a valve cartridge for a paint spray gun includes a cartridge body, a valve, and a needle. The cartridge body includes an outlet end having a cartridge outlet therethrough; a mount end; a fluid inlet extending through the cartridge body from an exterior of the cartridge body to a fluid chamber formed within the cartridge body, the fluid inlet disposed between the outlet end and the mount end; and a cartridge lock shaped to interface with a gun body of the paint spray gun to prevent rotation of the of the cartridge body about the valve axis and relative to the gun body. The valve is disposed within the cartridge body and configured to control flow of the paint from the fluid chamber through the cartridge outlet. The needle is partially disposed within the cartridge body and extending out of the cartridge body through the mount end, the needle movable along a valve axis to actuate the valve between an open state and a closed state.

According to yet another additional or alternative aspect of the disclosure, a valve cartridge for a paint spray gun includes a cartridge body, a valve, and a needle. The cartridge body includes an outlet end having a cartridge outlet therethrough; a mount end; a fluid inlet extending through the cartridge body from an exterior of the cartridge body to a fluid chamber formed within the cartridge body, the fluid inlet disposed between the outlet end and the mount end; and a mount lock shaped to interface with an axial retainer to prevent axial displacement of the cartridge body relative to the gun body. The valve is disposed within the cartridge body and configured to control flow of the paint from the fluid chamber through the cartridge outlet. The needle is partially disposed within the cartridge body and extending out of the cartridge body through the mount end, the needle movable along a valve axis to actuate the valve between an open state and a closed state.

According to yet another additional or alternative aspect of the disclosure, a paint spray gun includes a gun body supporting a trigger; a gun bore extending at least partially through the gun body; and a valve cartridge configured to interface with the gun body by axial movement of the valve cartridge along the gun axis, the valve cartridge interfacing with the gun body such that the valve cartridge can support or be supported by the gun body; the valve cartridge including a fluid inlet disposed outside of the gun bore.

According to yet another additional or alternative aspect of the disclosure, a valve cartridge for a paint spray gun includes a cartridge body and a valve disposed within the cartridge body and configured to control flow of the paint. The cartridge body includes an outlet end having a cartridge outlet therethrough; a mount end; a cartridge lock shaped to interface with a gun body of the paint spray gun to prevent rotation of the of the cartridge body about the valve axis and relative to the gun body; and a fluid inlet extending through the cartridge body from an exterior of the cartridge body to a fluid chamber formed within the cartridge body, the fluid inlet disposed between the cartridge outlet and the cartridge lock.

According to yet another additional or alternative aspect of the disclosure, a valve cartridge for a paint spray gun includes a cartridge body and a valve. The cartridge body includes an outlet end having a cartridge outlet therethrough; a mount end; a cartridge lock shaped to interface with a gun body of the paint spray gun to prevent rotation of the of the cartridge body about the valve axis and relative to the gun body; a mount lock shaped to interface with an axial retainer to prevent axial displacement of the cartridge body relative to the gun body; and a fluid inlet extending through the cartridge body from an exterior of the cartridge body to a fluid chamber formed within the cartridge body, the fluid inlet disposed between the cartridge outlet and the cartridge lock. The mount lock and the cartridge lock are disposed on an opposite axial side of the fluid inlet from the cartridge outlet. The valve is disposed within the cartridge body and configured to control flow of the paint from the fluid chamber through the cartridge outlet.

According to yet another additional or alternative aspect of the disclosure, a valve cartridge for a paint spray gun includes a cartridge body and a valve. The cartridge body includes an outlet end having a cartridge outlet therethrough; a mount end; and a fluid inlet extending through the cartridge body from an exterior of the cartridge body to a fluid chamber formed within the cartridge body, the fluid inlet disposed between the cartridge outlet and the cartridge lock. The valve is disposed within the cartridge body and configured to control flow of the paint from the fluid chamber through the cartridge outlet. The valve cartridge does not include a spring within a fluid flowpath through the cartridge body between the fluid inlet and the cartridge outlet.

According to yet another additional or alternative aspect of the disclosure, a valve cartridge for a paint spray gun includes a cartridge body and a valve. The cartridge body includes an outlet end having a cartridge outlet therethrough; a mount end; and a fluid inlet extending through the cartridge body from an exterior of the cartridge body to a fluid chamber formed within the cartridge body, the fluid inlet disposed between the cartridge outlet and the cartridge lock. The valve is disposed within the cartridge body and configured to control flow of the paint from the fluid chamber through the cartridge outlet. The valve cartridge does not include a spring.

According to yet another additional or alternative aspect of the disclosure, a method assembling a sprayer for spraying includes shifting a valve cartridge in a first axial direction along a bore axis of a gun bore of a gun body to interface the valve cartridge with the gun body, the valve cartridge disposed on the gun body such that a fluid inlet of the valve cartridge is not disposed within the gun body; and locking the valve cartridge to the gun body to axially retain the valve cartridge on the gun body.

According to yet another additional or alternative aspect of the disclosure, a needle for a valve of a sprayer includes a stem elongate along an axis and a ball. The stem includes an elongate body; and a ball mount disposed at a first axial end of the elongate body, the ball mount formed integrally with the elongate body. The ball mount having a first radial width and the elongate body having a second radial width, the first radial width larger than the second radial width. The ball is mounted on the ball mount.

According to yet another additional or alternative aspect of the disclosure, a needle for a valve of a sprayer includes a stem elongate along an axis between a first axial end and a second axial end, a needle tail mounted on the stem, and a ball mounted on the first axial end. The stem includes an elongate body; a tail mount formed at the second axial end; and a tail transition formed between the elongate body and tail mount. The elongate body having a first radial width and the rail mount having a second radial width, the first radial width larger than the second radial width. The needle tail is mounted on the stem and connected to the tail mount at a threaded interface and interfacing with the tail transition.

According to yet another additional or alternative aspect of the disclosure, a spray assembly includes a first housing; and a second housing having a fluid fitting connected thereto, the second housing mountable to the first housing in a plurality of orientations such that the fluid fitting extends outwards in multiple directions relative to the first housing.

According to yet another additional or alternative aspect of the disclosure, a method of forming a spray assembly for spraying a spray fluid onto a substrate includes mounting a second housing on a first housing such that a fluid fitting extending from the second housing is oriented in a first direction relative to the first housing; dismounting the second housing from the first housing; reorienting the second housing such that the fluid fitting extends in second direction relative to the first housing, the second direction different from the first direction; and mounting the second housing on the first housing such that the fluid fitting is oriented in the second direction.

According to yet another additional or alternative aspect of the disclosure, a method of forming a spray assembly for spraying a spray fluid onto a substrate includes mounting a second housing on a first housing such that a fluid fitting extending from the second housing is oriented in a first direction relative to the first housing; spraying the spray fluid with the fluid fitting extending in the first direction; mounting the second housing on the first housing such that the fluid fitting is oriented in a second direction relative to the first housing, the second direction different from the first direction; and spraying the spray fluid with the fluid fitting extending in the second direction.

### BRIEF DESCRIPTION OF THE DRAWINGS

FIG. 1 is an exploded view of a spray gun.

FIG. 2 is a cross-sectional view of the spray gun shown in FIG. 1 taken along line B-B in FIG. 1 and assembled together.

FIG. 3A is an isometric view of a valve cartridge.

FIG. 3B is a cross-sectional view of the valve cartridge shown in FIG. 3A taken along line B-B in FIG. 3A.

FIG. 4 is an isometric view of a gun body of a spray gun.

FIG. 5A is a first isometric view of a spray gun showing a valve cartridge in a first orientation.

FIG. 5B is a second isometric view of a spray gun showing a valve cartridge in a second orientation.

FIG. 5C is a third isometric view of a spray gun showing a valve cartridge in a third orientation.

FIG. 5D is a fourth isometric view of a spray gun showing a valve cartridge in a fourth orientation.

### DETAILED DESCRIPTION

The present disclosure relates to a spray gun. A valve cartridge of the spray gun includes flow control components within the flow path of spray fluid through the spray gun. The valve cartridge is mountable to and dismountable from the spray gun as a single component, facilitating removal and replacement of those fluid handling and control components.

The spray gun is reconfigurable such that an inlet fitting of the valve cartridge can be oriented in multiple directions extending from the spray gun, such as vertically, laterally, and positions therebetween. The repositionable inlet fitting facilitates efficient spraying by the user and allows a hose to connect to the spray gun from multiple angles. Facilitating the hose approaching the spray gun from multiple angles allows for efficient and ergonomic operation of the spray gun regardless of the position of the supply assembly (e.g., pump) relative to the spray gun.

The valve cartridge is configured to handle the fluid flow through the spray gun. The valve cartridge defines the fluid flowpaths of the spray gun such that no portion of the spray fluid flows directly within a gun body of the spray gun. The valve cartridge can receive the spray fluid directly from a supply hose and provide the spray fluid directly to a spray tip assembly such that the gun body is isolated from the flow of the spray fluid. The valve cartridge projects from the gun body such that the valve cartridge is cantilevered from the gun body. The spray tip housing is connected to the valve cartridge to mount to the valve cartridge and be supported by the valve cartridge.

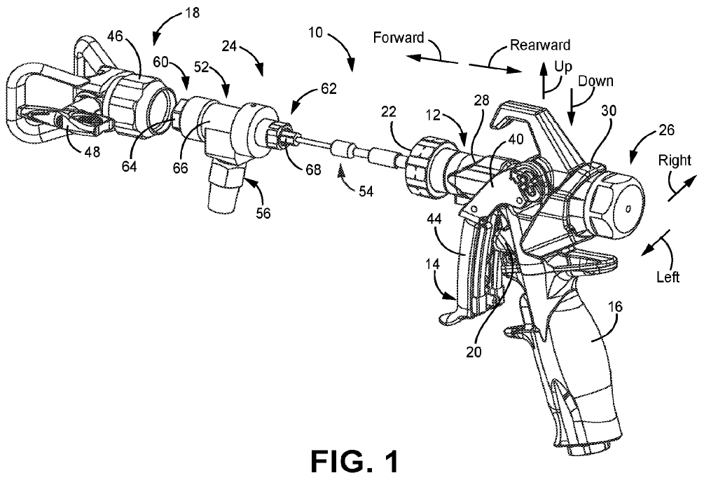

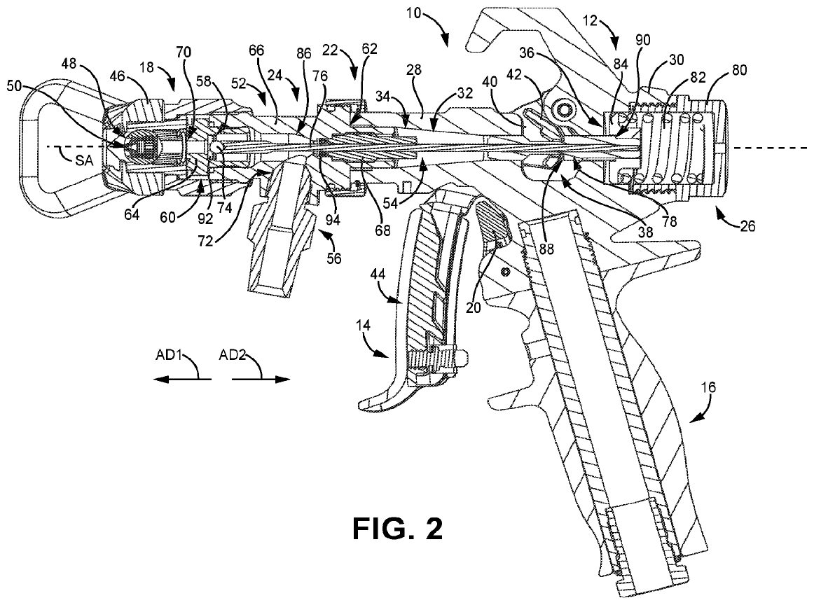

FIG. 1 is an exploded view of sprayer 10. FIG. 2 is a cross-sectional view of the sprayer 10 shown in FIG. 1 taken along line B-B in FIG. 1 and showing sprayer 10 assembled together. FIGS. 1 and 2 will be discussed together. Sprayer 10 includes gun body 12, trigger 14, handle 16, tip assembly 18, safety 20, mount ring 22, valve cartridge 24, and spring assembly 26. Gun body 12 includes front end 28, back end 30, and gun bore 32. Gun bore 32 is formed by mount bore 34 and spring bore 36. Trigger 14 includes arms 40, actuator 42, and pull 44. Tip assembly 18 includes tip mount 46 and spray tip 48. Spray tip 48 includes nozzle 50. Valve cartridge 24 includes cartridge body 52, needle 54, and fitting 56. Valve 58 is formed within valve cartridge 24. Cartridge body 52 includes diffuser housing 64, body housing 66, and packing nut 68. Cartridge outlet 70 and fluid inlet 72 are formed through cartridge body 52. Needle 54 includes ball 74, stem 76, and needle tail 78. Spring assembly 26 includes spring housing 80, spring 82, and spring cap 84.

Components can be considered to radially overlap when the components are disposed at a common position along an axis (e.g., along the spray axis SA) such that a radial line projecting that axis extends through each of those radially-overlapped components. Components can be considered to axially overlap when the components are disposed at common positions spaced radially from the axis (e.g., relative to spray axis SA) such that an axial line coaxial with or parallel to the axis extends through each of those axially-overlapped components.

Sprayer 10 is configured to receive pressurized flows of spray fluid (e.g., paint, lacquer, finishes, epoxies, and other coatings) through fitting 56 and emit a fluid spray through nozzle 50. Sprayer 10 is configured to generate a pressurized spray of the spray fluid and emit the spray fluid along spray axis SA. For example, the sprayer 10 can generate the spray as in a shaped spray pattern, such as a fan, cone, etc. Sprayer 10 is shown as a spray gun, in the example shown. Sprayer 10 can also be referred to as a spray assembly.

Handle 16 is connected to gun body 12. Handle 16 is configured to be gripped by one hand of a user to hold, support, and aim sprayer 10 while also allowing the user to actuate trigger 14. Handle 16 does not include a connector (e.g., fluid fitting) extending from the handle 16. The handle 16 does not include any fluid fittings for receiving spray fluid from the upstream source. Spray fluid does not flow through or within any passages within handle 16 in the example shown. Gun body 12 can be formed of any suitable material for receiving various components of sprayer 10 and for providing a pathway for pressurized paint. In some examples, gun body 12 is formed from a metal, such as aluminum.

Trigger 14 is mounted to gun body 12. Trigger 14 is configured to actuate an element of valve 58 within of valve cartridge 24 to cause spraying by sprayer 10 and spring assembly 26 is configured to actuate the element of valve 58 to stop spraying by sprayer 10. Arms 40 extend from opposite lateral sides of the pull 44 of trigger 14 and wrap around the lateral sides of gun body 12. As shown, arms 40 are formed as part of trigger 14, such that arms 40 are formed by material contiguous with at least a portion of pull 44. Arms 40 are connected to gun body 12 to mount trigger 14 to gun body 12. Arms 40, and thus trigger 14, are supported on gun body 12 by a pivot such that the pivot defines a pivot point about which trigger 14 pivots relative to gun body 12. Arms 40 connect trigger 14 to gun body 12 and are located on left and right lateral sides of gun body 12. Pull 44 of trigger 14 is centered with respect to the lateral sides of gun body 12, in the example shown. While two arms 40 are shown, it is understood that, in some examples, a single arm 40 can support trigger 14 and can be located on one side of gun body 12.

Actuator 42 extends between arms 40. Actuator 42 is configured to interface with a portion of needle 54 with valve cartridge 24 connected to gun body 12. Actuator 42 spans laterally between the two arms 40 of trigger 14. Actuator 42 extends laterally through void 38 formed in gun body 12. Actuator 42 can be a bridge that extends between, and connects to each of, the left and right arms 40. Actuator 42 can be formed from the same material as arms 40 or from a different material from arms 40. It is thereby understood that actuator 42 and arms 40 can be formed as a unitary part (i.e., single contiguous piece of material) or can be formed separately and fixed together. Actuator 42 can be metallic or can be formed from another suitably durable material for impacting needle tail 78 to actuate the valve 58 to an open state.

Safety 20 is attached to gun body 12 and is pivotable between a stowed, up position and a deployed, down position. Safety 20 interfaces with trigger 14 to prevent trigger 14 from being activated to cause spraying when in the deployed position. While safety 20 is described as mounted to gun body 12, it is understood that safety 20 can alternatively be mounted to handle 16. A trigger guard (not shown) extends from a bottom of handle 16 to gun body 12. The trigger guard surrounds trigger 14 to prevent inadvertent actuation of trigger 14. The trigger guard is disposed between trigger 14 and fitting 56 with fitting 56 extending vertically downward, as shown in FIG. 2.

Gun bore 32 is elongate along spray axis SA. In the example shown, gun bore 32 extends fully through gun body 12 along spray axis SA. It is understood, however, that not all examples are so limited. Mount bore 34 extends fully through front end 28 of gun body 12. Spring bore 36 is formed in back end 30 of gun body 12. The front end 28 and back end 30 are disposed on opposite axial sides of the void 38 along spray axis SA. Spring bore 36 extends fully through back end 30, in the example shown. The void 38 is thus disposed axially between the front end 28 and the back end 30.

Gun bore 32 is formed by the coaxial mount bore 34 and spring bore 36 with void 38 disposed axially therebetween. Mount bore 34 decreases in width from the forward portion of mount bore 34 towards void 38. As such, the forward end of mount bore 34 has a larger diameter than the back end of mount bore 34. Spring bore 36 has varying diameters. In the example shown, the front end of spring bore 36 (at void) has a smaller diameter than the back end of spring bore 36 (facing away from void 38). The smaller diameter portions of mount bore 34 and spring bore 36 can interface with needle 54 to maintain alignment of needle 54 on spray axis SA.

Void 38 is formed such that void 38 is open to the lateral and top sides of gun body 12. In the example shown, void 38 is formed such that void 38 is open on the left side of gun body 12, the right side of gun body 12, and vertically upward relative to gun body 12. Such a configuration facilitates movement of actuator 42 into and out of engagement with needle 54 of valve cartridge 24, as discussed in more detail in U.S. application Ser. No. 16/773,122, filed Jan. 27, 2020, entitled “SPRAY GUN AND COMPONENTS FOR SPRAYING PAINTS AND OTHER COATINGS,” and assigned to Graco Minnesota, Inc., the disclosure of which is hereby incorporated by reference in its entirety (hereinafter referred to as “the '122 application”).

Spring bore 36 is formed in back end 30 of gun body 12. Spring bore 36 extends fully through gun body 12 between void 38 and the rearmost portion of back end 30. In the example shown, spring bore 36 is closed by spring housing 80. While spring bore 36 is shown as extending fully through back end 30, it is understood that some examples include a spring bore 36 that does not extend fully through back end 30. The spring bore 36 can be closed by a removable component or by being configured as closed during manufacturing of gun body 12. In the example shown, spring bore 36 extends fully through gun body 12 but is closed by spring assembly 26; specifically, spring bore 36 is closed by spring housing 80.

Spring assembly 26 is supported by gun body 12. Spring assembly 26 is supported by back end 30 of gun body 12. Spring assembly 26 is at least partially disposed within the spring bore 36. Spring assembly 26 interfaces with a portion of needle 54 to bias valve 58 towards a closed state. Spring cap 84 interfaces with needle 54 such that spring cap 84 can transmit biasing force to needle 54 to bias valve 58 into the closed state. Spring housing 80 is mounted to gun body 12. Spring 82 is at least partially disposed within spring bore 36. Spring 82 is captured between an end wall of spring housing 80 and a flange of spring cap 84. While spring 82 is disposed outside of the fluid passages of sprayer 10 in the example shown, it is understood that not all examples are so limited. For example, some examples of valve cartridge 24 can include a spring 82 disposed within fluid chamber 86 that biases needle 54 in first axial direction AD1. Such a configuration can include a direct interface between spring 82 and needle 54 or indirect interface being spring 82 and needle 54 (e.g., similar to the interface utilizing the spring cap 84, as shown).

Spring cap 84 extends radially outward from needle 54. Spring cap 84 extends radially outward from needle 54 to engage with spring 82. Spring 82 is radially larger than needle 54. As such, needle 54 can pass fully through spring 82 without directly engaging with spring 82 (e.g., if spring cap 84 and spring housing 80 were not present). In the example shown, spring cap 84 interfaces with needle tail 78 of needle 54.

Mount bore 34 is formed fully through front end 28 of gun body 12. Mount bore 34 extends between the forward-most portion of gun body 12 and void 38. Valve cartridge 24 is mountable to sprayer 10 at mount bore 34. Valve cartridge 24 resides substantially outside of gun bore 32, and further, fluid travels directly to valve cartridge 24 through fluid inlet 72 and not through gun body 12. Examples of the present application have a dry internal gun body 12. Spray fluid does not flow within any passage within gun body 12. Spray fluid does not directly contact the material forming gun body 12. In the example shown, the spray fluid is routed by a hose directly to valve cartridge 24 through fluid inlet 72. In this aspect, gun body 12 is not in fluid communication with any spray fluid.

Valve cartridge 24 is mountable to gun body 12. Valve cartridge 24 can also be referred to as a spray cartridge, fluid cartridge, or paint cartridge. In the example shown, valve cartridge 24 is mountable to gun body 12 by a portion of valve cartridge 24 extending into mount bore 34. Valve cartridge 24 is mounted to gun body 12. Valve cartridge 24 is a wet component that defines spray fluid flowpaths of the spray fluid circuit through sprayer 10. Gun body 12 is a dry component that does not define any spray fluid flowpaths through the spray fluid circuit. The gun body 12 supports valve actuating components such that those components are not disposed in the spray fluid flowpath. The spring 82 is not in the spray fluid flowpath. The actuator 42 is not in the spray fluid flowpath. The trigger 14 pulls the needle 54 to cause opening of the valve 58.

Cartridge body 52 is partially disposed within mount bore 34 in the example shown. It is understood that, in some examples, cartridge body 52 can be disposed fully outside of mount bore 34. For example, a portion of cartridge body 52 can extend over and receive a portion of gun body 12. In the example shown, cartridge body 52 is formed by multiple components fixed together.

The valve cartridge 24 shown does not include an integral biasing mechanism. The trigger 14 (configured to pull needle 54 in second axial direction AD2) is supported by gun body 12. The spring assembly 26 (configured to push needle 54 in first axial direction AD1) is supported by gun body 12. Valve cartridge 24 is mounted to gun body 12 by dual dynamic interfaces in addition to the static anti-rotation interface and the static axial retention interface. The first dynamic interface is between actuator 42 and needle 54. The second dynamic interface is between spring assembly 26 and needle 54. In the example shown, the first and second dynamic interfaces are formed and broken during mounting and dismounting of valve cartridge 24 on gun body 12. The components configured to generate the biasing forces remain mounted to gun body 12 with valve cartridge 24 dismounted. Trigger 14 and spring assembly 26 remain mounted to gun body 12 with valve cartridge 24 dismounted. Trigger 14 and spring assembly 26 remain connected to and supported by gun body 12 throughout the mounting and dismounting of valve cartridge 24, in the example shown. As discussed in the '122 application, the trigger 14 can remain mounted to and supported by the gun body 12 throughout the mounting process, whether positioned to actuate needle 54 or shifted to allow for needle 54 to pass axially by actuator 42.

Cartridge body 52 defines fluid handling portions of valve cartridge 24. Outlet end 60 of cartridge body 52 is oriented in first axial direction AD1. Mount end 62 of cartridge body 52 is oriented in second axial direction AD2. Outlet end 60 can interface with tip assembly 18 to connect tip assembly 18 and valve cartridge 24. For example, outlet end 60 can include threads formed on an outer side of outlet end 60. Mount end 62 can interface with sprayer 10 to connect valve cartridge 24 to sprayer 10.

Body housing 66 is a main body component of cartridge body 52. Fluid chamber 86 is formed within body housing. Other component of valve cartridge 24 can be connected to and/or supported by body housing 66. Body housing 66 includes a downstream opening facing in first axial direction AD1 and an upstream opening facing in second axial direction AD2. In the example shown, fluid inlet 72 is formed through body housing 66. Fitting 56 is mounted to body housing 66 at fluid inlet 72.

Diffuser housing 64 is mounted to body housing 66. Diffuser housing 64 is connected to body housing 66 at the downstream opening of body housing 66. Diffuser housing 64 is disposed at outlet end 60 of cartridge body 52. Diffuser housing 64 extends into body housing 66. Diffuser housing 64 projects outward from body housing 66 such that diffuser housing 64 is disposed partially within body housing 66 and partially outside of body housing 66. In the example shown, diffuser housing 64 forms an axial-most portion of cartridge body 52 in first axial direction AD1. In the example shown, diffuser housing 64 forms an axial-most portion of valve cartridge 24 in first axial direction AD1.

Seat 92 of valve 58 is supported cartridge body 52. In the example shown, seat 92 is supported by diffuser housing 64. Seat 92 is positioned upstream of cartridge outlet 70. Cartridge outlet 70 is formed through cartridge body 52. In the example shown, cartridge outlet 70 is formed through diffuser housing 64. The pressurized spray fluid exits valve cartridge 24 through cartridge outlet 70. Cartridge outlet 70 is disposed coaxially on spray axis SA.

Packing nut 68 is mounted to body housing 66. Packing nut 68 is connected to body housing 66 at the upstream end of body housing 66. Packing nut 68 is disposed at mount end 62 of cartridge body 52. Packing nut 68 extends into body housing 66. In the example shown, packing nut 68 projects axially outward from body housing 66 such that packing nut 68 is disposed partially within body housing 66 and partially outside of body housing 66. In the example shown, packing nut 68 forms an axial-most portion of cartridge body 52 in second axial direction AD2. In the example shown, packing nut 68 forms an axial-most portion of valve cartridge 24 in second axial direction AD2. Packing nut 68 can also be referred to as a seal body that supports the seal within body housing 66.

Packing seal 94 is disposed within cartridge body 52. Packing seal 94 seals an upstream end of fluid chamber 86 within cartridge body 52. Packing seal 94 engages with cartridge body 52 and needle 54 to fluidly seal the fluid chamber 86. Packing seal 94 is axially supported by packing nut 68. Packing seal 94 is axially supported between a shoulder formed by body housing 66 and packing nut 68. In the example shown, packing seal 94 is formed as a u-cup seal with an open end oriented into the fluid chamber 86 (oriented in first axial direction AD1 in the example shown) such that packing seal 94 is energized by the pressurized fluid within fluid chamber 86.

Fitting 56 is connected to cartridge body 52. Fitting 56 includes a first end interfacing with cartridge body 52 and a second end configured to interface with a hose assembly to receive flows of spray fluid from the hose of the hose assembly. Fitting 56 is connected to fluid inlet 72 of valve cartridge 24. Specifically, the first end of fitting 56 extends into fluid inlet 72. Fitting 56 can be mounted to cartridge body 52 in nay desired manner, such as by interfaced threading. In some examples, fitting 56 can be connected to cartridge body 52 such that inlet fitting 56 cannot be removed from cartridge body 52 except by special tools or by destroying the operability of valve cartridge 24. For example, fitting 56 can be threadedly mounted to cartridge body 52 and secured with thread lock adhesive.

Fitting 56 is pitched relative to a radial line extending from the spray axis SA. As such, an axis of the flow handling bore through fitting 56 is transverse to radial lines extending from spray axis SA. In the example shown, fitting 56 is pitched forward such that the second end of fitting 56 that connects to the hose assembly is closer to spray tip 48 than the first end of fitting 56 that connects to cartridge body 52. The pitched configuration of fitting 56 facilitates user access to trigger 14 with fitting 56 oriented downwards, at a six o'clock position, as the fitting 56 is pitched similar to pull 44 and does not interfere with the user's fingers. The fitting 56 can, in some examples, form a portion of a trigger guard when in the six o'clock position.

Needle 54 is disposed partially within cartridge body 52. Ball 74 is connected to an end of stem 76 such that ball 74 is supported by stem 76. Ball 74 is configured to engage with seat 92 to seal the flowpath through valve 58 with valve 58 in the closed state. Ball 74 can be considered to form a movable valve component of the valve 58 that engages with seat 92 to place valve 58 in the closed state and disengaged from seat 92 to place valve 58 in the open state. Ball 74 can also be referred to as a valve seal. Ball 74 shifts axially away from seat 92 to open a flowpath through valve 58, allowing pressurized spray fluid to flow from fluid chamber 86 through valve 58 and out of valve cartridge 24, with valve 58 in the open state. Ball 74 shifts axially towards seat 92 and into engagement with seat 92 to close the flowpath through valve 58, preventing pressurized spray fluid from flowing through valve 58 and out of valve cartridge 24. In the example shown, ball 74 is mounted to a radially-enlarged portion of stem 76.

Stem 76 is axially elongate. Stem 76 extends in second axial direction AD2 away from seat 92 and ball 74. Stem 76 extends through packing seal 94 and packing nut 68. Stem 76 interfaces with packing seal 94 at a sliding fluid seal that fluidly seals fluid chamber 86. Needle tail 78 is mounted to an axial end of stem 76 opposite the axial end of stem 76 on which ball 74 is mounted. Needle tail 78 mounts to stem 76. Needle tail 78 is connected to stem 76 such that needle tail 78 and stem 76 move together along axis SA. In some examples, the needle tail 78 can be mounted to stem 76 by a threaded interface therebetween. For example, stem 76 can include exterior threading and needle tail 78 can include interior threading. The needle tail 78 can also be referred to as a slider. The stem 76 and needle tail 78 can together be referred to as a slider assembly. Needle tail 78 is configured to interface with a needle displacer of the paint spray gun to cause the valve 58 to shift between open and closed states.

Needle tail 78 includes actuator shoulder 88 and spring shoulder 90. Actuator shoulder 88 is configured to interface with actuator 42 such that trigger 14 can exert force on needle 54 by actuator 42 acting on actuator shoulder 88 of needle tail 78 to displace needle 54 in second axial direction AD2. Actuator 42 can engage actuator shoulder 88 and actuate valve 58 to an open state by actuator 42 pushing needle tail 78 and thus stem 76 and ball 74, in second axial direction AD2. Spring shoulder 90 is configured to interface with a component of spring assembly 26 such that spring 82 can exert biasing force on needle 54 at spring shoulder 90 to displace needle 54 in first axial direction AD1. In the example shown, spring cap 84 engages with spring shoulder 90 to bias needle 54 in first axial direction AD1.

All components of valve cartridge 24 are removable from gun body 12 together as a single piece and do not require separate removal from gun body 12. The various components of valve cartridge 24 are connected to each other independent of gun body 12 and other parts of sprayer 10. For example, the various components of valve cartridge 24 can be threaded or press fit to hold the components together, such that the components stay together regardless of the orientation of valve cartridge 24 (e.g., the components do not freely slide apart). Valve cartridge 24 remains a unitary part when outside of gun body 12 such that the various components of valve cartridge 24 do not freely separate.

Valve cartridge 24 is mountable to and dismountable from gun body 12 by axial movement of valve cartridge 24 along spray axis SA and relative to gun body 12. In the example shown, valve cartridge 24 is mountable to gun body 12 by solely axial movement of valve cartridge 24 relative to spray axis SA. During mounting, valve cartridge 24 shifts in second axial direction AD2 relative to gun body 12. Needle 54 is a first component of valve cartridge 24 to enter into gun body 12. Needle 54 passes through mount bore 34 and void 38 and into spring bore 36. Specifically, needle tail 78 and stem 76 form the portions of needle 54 that enter into mount bore 34 and pass axially through mount bore 34. That portion formed by needle tail 78 and stem 76 can be considered to form a slider assembly that shifts into engagement with spring assembly 26. Needle tail 78 and valve stem 76 pass through void 38 and into spring bore 36. Needle tail 78 enters into the central opening through spring cap 84 and spring cap 84 engages with spring shoulder 90.

Cartridge body 52 enters into gun bore 32. Specifically, cartridge body 52 enters into mount bore 34 through a front opening of mount bore 34. Cartridge body 52 interfaces with gun body 12 such that cartridge body 52 is rotationally fixed relative to gun body 12 about spray axis SA and axially fixed relative to gun body 12 along spray axis SA.

Valve cartridge 24 interfaces with the gun body 12 at an anti-rotation interface that prevents valve cartridge 24 from rotating on spray axis SA relative to gun body 12. In the example shown, valve cartridge 24 includes at least one rotational engagement member that prevents rotation of valve cartridge 24 relative to gun body 12 when valve cartridge 24 is mounted to gun body 12.

In some examples, the anti-rotation interface is formed by a male-female structure used to stop rotation of valve cartridge 24 about the spray axis SA and relative to gun body 12. Such male-female engagement prevents rotation of valve cartridge 24 on spray axis SA. For example, one of cartridge body 52 and gun body 12 can include one or more projections and the other of cartridge body 52 and gun body 12 can include one or more recesses for receiving the one or more pegs. The projections can be radially offset from the spray axis SA, such as by one or more pegs extending from one of the gun body 12 and the valve cartridge 24 at locations radially offset from the spray axis SA. The at least one projection attached to valve cartridge 24 can align with a similarly shaped recess in the gun body 12. In some examples, valve cartridge 24 can interface with gun body 12 at a gear/teeth engagement member. For example, valve cartridge 24 and gun body 12 can include toothed rings that mate to inhibit rotation of the valve cartridge 24 relative to the gun body 12.

In some examples, a portion of cartridge body 52 can include a cross-sectional shape that is non-circular orthogonal to spray axis SA and the mount bore 34 of gun body 12 can similarly include a mating cross-sectional shape that is non-circular orthogonal to spray axis SA. The mating non-circular shapes prevent relative rotation between cartridge body 52 and gun body 12. For example, the cross-sections can be oval, square, triangular, rectangular, star shaped, or another polygonal shape. The portions of the cartridge body 52 and gun body 12 formed at the anti-rotation interface can extend fully about the spray axis SA. The anti-rotation interface can, in some examples, support the valve cartridge 24 on the gun body 12 such that the valve cartridge 24 is cantilevered from the gun body 12. For example, valve cartridge 24 can include one of a contoured projection and contoured recess, and the gun body 12 can include the mating contoured recess and contoured projection. In the example shown, the projection extends from valve cartridge 24 and is aligned on the spray axis SA. The anti-rotation interface can thus be formed about and aligned on the spray axis SA.

Multiple positions of the anti-rotation interface are distributed around the circumference of the bore of gun body 12. The dispersion of the clock positions of the anti-rotation interface allows valve cartridge 24 to be secured to gun body 12 in varying rotational positions. Such engagement allow fluid inlet 72 to be fixed in various orientations about the spray axis SA. For example, valve cartridge 24 may be secured to gun body 12 so that fluid inlet 72 is oriented down (i.e., in plane with the cross section of FIG. 2). Alternatively, a user may which to secure valve cartridge 24 to gun body 12 so that fluid inlet 72 is perpendicular to, or alternatively, at an angle offset from the plane of the cross section in FIG. 2. Fluid inlet 72 can be oriented at various radial positions around the spray axis SA. In some examples, the fluid inlet 72 can be disposed at various clock positions when viewed looking in first axial direction AD1 along the spray axis A, such as at 12 o'clock, 3 o'clock, 6 o'clock, 9 o'clock, and various positions therebetween. In some examples, valve cartridge 24 can be mountable to gun body 12 at a limited number of clock positions, such as one of two, three, four, or more clock positions. In some examples, valve cartridge 24 is mountable at infinite radial positions about the spray axis SA.

Valve cartridge 24 is axially retained on gun body 12. In the example shown, mount ring 22 interfaces with valve cartridge 24 and gun body 12 to axially retain valve cartridge 24 on gun body 12. Mount ring 22 can be considered to form a lock ring. The mount ring 22 can secure the anti-rotation interface by preventing relative axial displacement between valve cartridge 24 and gun body 12, rotationally locking the position of fitting 56 about the spray axis SA.

Mount ring 22 can be formed as a threaded ring such that the axial retention interface is formed as a threaded interface. In the example shown, mount ring 22 is supported by gun body 12 and retained on gun body 12. Specifically, mount ring 22 is disposed on and supported by front end 28 of gun body 12. In such an example, the mount ring 22 can be considered to form a component of the gun body 12. Cartridge body 52 includes threading formed at mount end 62. The threading is formed on body housing 66, in the example shown. In the example shown, the threaded interface is formed by exterior threads formed on cartridge body 52 and internal threads formed on mount ring 22. In other examples, mount ring 22 can be supported on cartridge body 52 and connected to gun body 12 by a threaded interface. For example, exterior threads can be formed on front end 28 and interior threads can be formed on the mount ring 22. In such examples, mount ring 22 can be considered to form a component of valve cartridge 24.

Tip assembly 18 is attached to valve cartridge 24. Tip assembly 18 is configured to atomize the spray fluid emitted from spray valve 58. Tip assembly 18 can be considered to be indirectly connected with other components of sprayer 10 (e.g., gun body 12) by directly interfacing with a mounting surface formed by cartridge body 52 of valve cartridge 24. Valve cartridge 24 forms an unsupported bridge between tip mount 46 and gun body 12. Valve cartridge 24 and tip assembly 18 can be considered to form a fluid handling and atomizing component of sprayer 10. The fluid handling and atomizing component is cantilevered from gun body 12.

Tip assembly 18 is connected to valve cartridge 24 by tip mount 46. Tip mount 46 can be removably mounted to valve cartridge 24. For example, tip mount 46 can fit over outlet end 60 of valve cartridge 24, which can also be referred to as a front end of valve cartridge 24. Tip mount 46 can include internal threading that interfaces with external threading on the outlet end 60 to fix tip mount 46 to valve cartridge 24.

Spray tip 48 is mounted in a bore of tip mount 46. Nozzle 50 is formed in spray tip 48. Nozzle 50 can be formed from carbide or another metal. Nozzle 50 includes a narrow outlet that is configured to atomize the paint exiting nozzle 50 into a spray fan. Spray tip 48 is mounted in tip mount 46 such that spray tip 48 can be rotated 180-degrees to reverse the direction of paint flow through nozzle 50. Rotating tip mount exposes a larger opening than the opening of nozzle 50. That larger opening is disposed on the opposite side of spray tip 48 from nozzle 50. Any clogs can be dislodged from spray tip 48 and ejected from that larger opening with spray tip 48 in the reversed position (i.e., with the larger opening pointed in first axial direction AD1).

Valve cartridge 24 is disposed partially within gun body 12 but substantially outside of gun body 12. A majority of the axial length of cartridge body 52 relative to the spray axis VA is disposed outside of the gun bore 32. Paint is output from valve cartridge 24 through cartridge outlet 70, flows through tip assembly 18, and is emitted as an atomized fluid spray through nozzle 50.

During spraying, spray fluid enters inlet fitting 56 from a hose connected to inlet fitting 56. The spray fluid flows through fluid inlet 72 and into the fluid chamber 86 to pressurize fluid chamber 86. The spray fluid does not flow through gun body 12. Spring 82 biases needle 54 in first axial direction AD1 to maintain valve 58 in a closed state. Spring 82 prevents the pressure within fluid chamber 86 from forcing valve 58 to an open state. In the example shown, spring 82 is disposed outside of the fluid flowpath through sprayer 10.

The trigger 14 is actuated and drives needle 54 in second axial direction AD2. The ball 74 disengages from the seat 92 to open valve 58. The spray fluid flows through inlet fitting 56, cartridge body 52 and tip assembly 18. The paint flows through the open valve 58 and spray tip 48 to generate the fluid spray.

The spray fluid does not contact the gun body 12. Gun body 12 being removed from the fluid flowpath through valve cartridge 24 prevents the spray fluid from accumulating on the surfaces forming the spray fluid flowpath through gun body 12. Valve cartridge 24 requires less flushing as surfaces of gun body 12 do not require cleaning because gun body 12 is not exposed to the spray fluid. Gun body 12 being removed from the fluid pathway thereby provides for less solvent use, saving materials and costs.

The spray fluid does not contact the spring 82. Spring 82 being removed from the fluid flowpath through valve cartridge 24 prevents the spray fluid from accumulating on the surfaces of spring 82. Valve cartridge 24 requires less flushing as surfaces of spring 82 do not require cleaning because spring 82 is not exposed to the spray fluid. Spring 82 being removed from the fluid pathway thereby provides for less solvent use, saving materials and costs.

The trigger 14 is released to stop spraying of the paint. With trigger released, spring 82 drives needle 54 in first axial direction AD1, causing ball 74 to engage seat 92, closing valve 58 and stopping spraying of the paint. The spring 82 exerts driving pressure directly on needle tail 78 that is transmitted to stem 76 and then to ball 74 via stem 76 to displace ball 74.

During operation, and unlike the embodiments of the '122 application, paint does not enter sprayer 10 via a connector of the handle 16. Instead, the paint travels directly to valve cartridge 24 via fluid inlet 72. The spray fluid does not flow through passages within gun body 12. No portion of inlet fitting 56 is disposed within gun body 12 or extends into gun body 12. No portion of the inlet fitting 56 passes through an opening in gun body 12 to engage with cartridge body 52.

In the example shown, packing seal 94 is spaced axially in the first axial direction AD1 from the axial face of front end 28 of gun body 12. The packing seal 94 being spaced in first axial direction AD1 from gun body 12 positions all fluid passages of the fluid circuit through sprayer 10 outside of the gun body 12. No fluid passage of the fluid circuit through sprayer 10 is within handle 16. Positioning the fluid handing passages outside of gun body 12 isolates surfaces of gun body 12 from the spray fluid flowing through sprayer 10. Gun body 12 remains a dry component of sprayer 10 throughout operation of sprayer 10. As such, bores and other surfaces of gun body 12 on which the spray fluid can accumulate do not require cleaning and other maintenance necessary for fluid handling components, saving material and costs. Maintaining gun body 12 as a dry component prevents curing within the gun body 12 that could destroy operability of the gun body 12. In the example shown, valve cartridge 24 can be removed and replaced with a new valve cartridge 24 on the same gun body 12 if curing occurs, without concern of any curing in gun body 12.

Valve cartridge 24 can be removed from gun body 12 for servicing and/or replacement. Trigger 14 is actuated to remove actuator 42 from needle tail 78, as discussed in the '122 application. Mount ring 22 is actuated to disconnect the axial retention interface holding valve cartridge 24 on gun body 12. In the example shown, mount ring 22 can be unthreaded from cartridge body 52 by rotating mount ring 22 in a first rotational direction about the spray axis SA (e.g., one of clockwise and counterclockwise). Valve cartridge 24 is pulled in first axial direction AD1 disengaging valve cartridge 24 from gun body 12 and breaking the rotational lock interface. Valve cartridge 24 can be pulled by solely axial movement of the valve cartridge 24 relative to gun body 12. The valve cartridge 24 does not require rotation or movement to dismount valve cartridge 24 from gun body 12. Cartridge body 52 remains stationary alone the spray axis SA as the axial retention interface is formed and broken. In the example shown, a portion of valve cartridge 24 is pulled out of mount bore 34. Needle 54 moves in first axial direction AD1 and out of gun bore 32.

Dismounting valve cartridge 24 from gun body 12 disconnects the wet components of sprayer 10 from the dry components of sprayer 10. The fluid handling components can be disconnected from and dismounted from the dry components without having to break any in within the fluid path (spray tip 48, valve cartridge 24, and the supply hose can remain connected together). The dry components can then be placed aside and protected from contamination from any spray fluid that may leak or drip while the wet components of sprayer 10 are disconnected. Disconnecting the valve cartridge 24 to facilitate axial movement of valve cartridge 24 does not require accessing a component through back end 30. Disconnecting the valve cartridge 24 to facilitate axial movement of valve cartridge 24 does not require removal or access to a set screw. In some examples, only a single axial locking component (e.g., mount ring 22) needs to be accessed and manipulated to axially unlock valve cartridge 24. Trigger 14 interfaces with stem 76 but does not axially retain the valve cartridge 24 on the gun body 12.

In the example shown, dismounting valve cartridge 24 disconnects valve 58 from both axial displacers of sprayer 10. The trigger 14 forms a first axial displacer that is configured to actuate the valve 58 to the open state. The spring assembly 26 is configured to actuate the valve 58 to the closed state. The trigger 14 and spring assembly 26 remain mounted on the gun body 12 with the valve cartridge 24 dismounted from gun body 12. The trigger 14 and spring assembly 26 remain mounted on the gun body 12 during both mounting and dismounting of valve cartridge 24 from the gun body 12.

In the example shown, trigger 14 is manipulated such that trigger 14 cannot actuate valve cartridge 24 without manipulating a component of valve cartridge 24. In the example shown, no component is unthreaded from or disconnected from valve cartridge 24 to manipulate trigger 14. In some examples, trigger 14 is manipulated by removing a pin connecting trigger 14 to needle 54.

Tip mount 46 can be dismounted from valve cartridge 24. For example, tip mount 46 can be dismounted from valve cartridge 24 by unthreading tip mount 46 from cartridge body 52. The supply hose can be disconnected from valve cartridge 24. For example, the supply hose can be disconnected from fitting 56 by unthreading, a quick-connect fitting, etc. Valve cartridge 24 can then be serviced or, in some examples, discarded.

A second valve cartridge 24 (new or the same as the first valve cartridge 24) can then be connected to gun body 12 for spraying. The second valve cartridge 24 can be connected to the same hose to spray the same paint or to a different hose to spray a different paint (e.g., different color, finish, etc.). The tip assembly 18 and hose can be connected to the second valve cartridge 24 to form the fluid handling section prior to mounting to gun body 12.

Needle 54 passes through mount bore 34 and into engagement with spring assembly 26. The anti-rotation interface between cartridge body 52 and gun body 12 is engaged. The axial retention interface between valve cartridge 24 and gun body 12 is formed. The trigger 14 is interfaced with needle 54 to facilitate trigger 14 transmitted a driving force to needle 54. Trigger 14 can be interfaced with needle 54 before or after engaging the axial retention interface. Spraying can then be resumed by actuating trigger 14.

The same gun body 12 can be used for spraying different configurations of paint without requiring cleaning of gun body 12 (e.g, by connecting a different fluid supply to the second valve cartridge 24), reducing downtime and increasing the efficiency of spray operations. As such, the user can utilize a single gun body 12 for spraying multiple different paints, reducing costs associated with having multiple gun bodies 12 that require cleaning and that directly handle the spray fluid.

Valve cartridge 24 is disposed partially within gun bore 32 and substantially outside of gun bore 32. Cartridge body 52 is cantilevered from gun body 12 such that the fluid passages through valve cartridge 24 are not disposed within or formed by gun body 12, preventing contamination of the gun body 12 by the spray fluid.

Valve cartridge 24 can be mounted to and dismounted from gun body 12. Valve cartridge 24 contains fluid pathways and isolates passages and openings of gun body 12 from the spray fluid. Valve cartridge 24 can be a replaceable component of sprayer 10 that allows for continued use of gun body 12 and handle 16 by simply replacing valve cartridge 24 with a new valve cartridge 24. Gun body 12 can thus be used to continuing spraying the same paint or a different spray fluid.

In the example shown, no fluid seals are disposed between valve cartridge 24 and gun body 12. Valve cartridge 24 does not include any exterior seals. Cartridge body 52 does not include any seal grooves formed in the exterior surface of cartridge body 52 that are configured to receive a seal (e.g., an elastomer o-ring seal). The gun body 12 does not include any interior seals. The gun body 12 does not include any seals within the mount bore 34 that are configured to interface with the cartridge body 52. The mount bore 34 does not include any seal grooves formed in the surface defining gun bore 32. Removing the seals between gun body 12 and valve cartridge 24 decreases costs.

All spray fluid seals of sprayer 10 are carried by valve cartridge 24. The spray fluid seals are exposed to the spray fluid during operation and are thus fully within the cartridge body 52. The fluid seals of valve cartridge 24 are interior seals within the cartridge body 52. Exterior fluid seals (whether on a valve cartridge on in a mount bore of a gun body) are exposed to the environment when the valve cartridge is dismounted from the gun body. Valve cartridge 24 includes only interior fluid seals, preventing exposure of the fluid seals to environmental contaminants. For example, if valve cartridge 24 is inadvertently dropped, the fluid seals are protected from the ground surface and do not risk damage or contamination.

In the example shown, spring 82 is removed from the fluid flowpath such that spring 82 is not exposed to the spray fluid. Spring 82 does not require flushing. Spring 82 is supported by gun body 12 and is separate from valve cartridge 24 such that spring 82 can remain mounted on gun body 12 while valve cartridge 24 is removed and replaced. Spring 82 can bias multiple different needles 54 of different valve cartridges 24 in first axial direction AD1. The spring 82 not being integrated into the valve cartridge 24 decreases the cost of the valve cartridge 24. In the example shown, the spring assembly 26 is connected to gun body 12 by shifting in second axial direction AD2. Valve cartridge 24 is mounted to gun body 12 by moving in an opposite axial direction from spring assembly 26, by shifting valve cartridge 24 in first axial direction AD1.

The anti-rotation interface is formed such that valve cartridge 24 can be rotationally locked in multiple rotational positions on the spray axis SA. Valve cartridge 24 can be mounted to gun body 12 with fitting 56 extending in a variety of directions relative to cartridge body 52. Fitting 56 being positioned at different orientations allows for efficient and ergonomic operation of sprayer 10. For example, fitting 56 can be oriented vertically downward in the same direction as handle 16 during spraying of a wall or oriented vertically upward on an opposite vertical side of gun body 12 from handle 16 when the fluid source is positioned vertically above the operator (e.g., spraying in a manhole). The fitting 56 can be oriented laterally, either horizontally or at positions between vertical and horizontal, on either lateral side of gun body 12. Fitting 56 can extend laterally to provide a comfortable spray arrangement for an operator, thereby increasing the efficiency of spray operations and providing a more comfortable, ergonomic spraying experience to the user. The same valve cartridge 24 can be mounted and maintained in multiple ones of the orientations. Sprayer 10 is thereby formed as a modular spray gun in which the same components are reconfigurable to provide multiple differently configured sprayers 10.

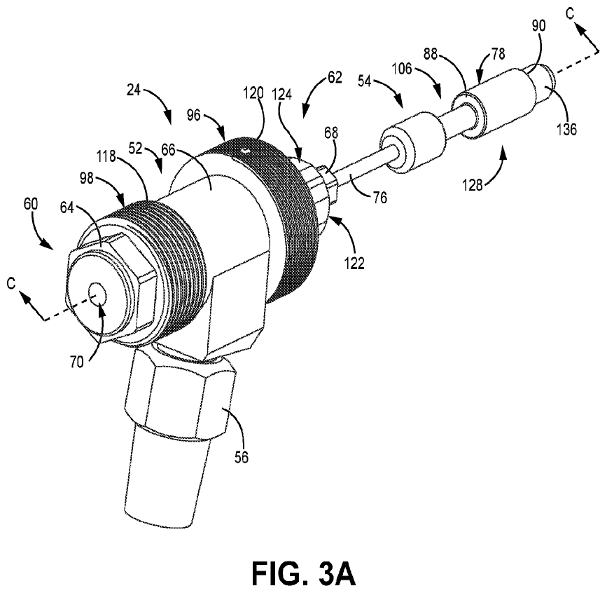

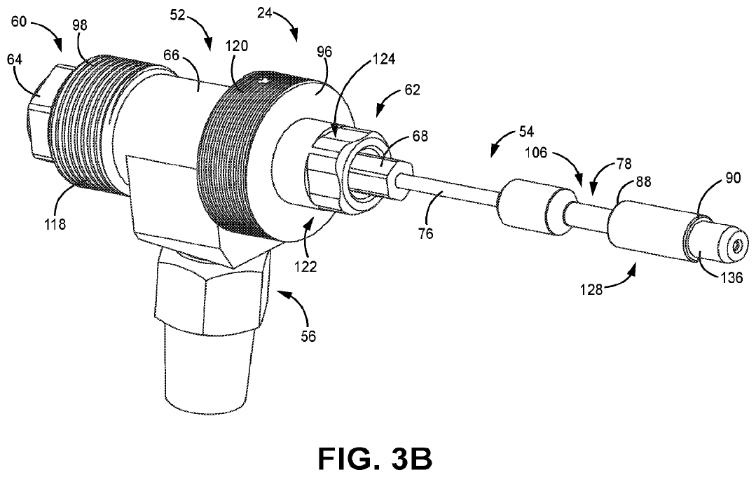

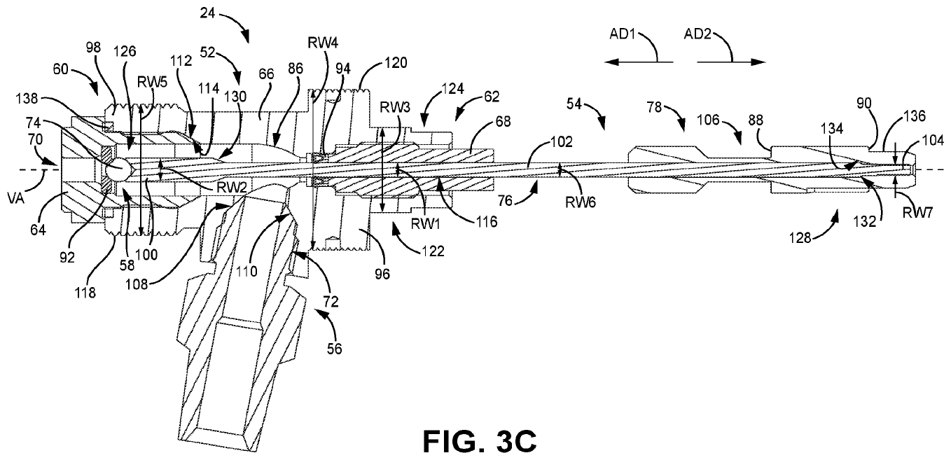

FIG. 3A is a first isometric view of valve cartridge 24. FIG. 3B is a second isometric view of valve cartridge 24. FIG. 3C is a cross-sectional view taken along line C-C in FIG. 3A. FIGS. 3A-3C will be discussed together. Valve cartridge 24 includes cartridge body 52, needle 54, inlet fitting 56, valve 58, and cartridge lock 124. Cartridge body 52 extends between outlet end 60 and mount end 62 and defines fluid chamber 86. Cartridge body 52 includes body housing 66, diffuser housing 64, packing nut 68, cartridge outlet 70, fluid inlet 72, projection 122, mount block 96, and tip block 98. Needle 54 includes ball 74, stem 76, and needle tail 78. Stem 76 includes ball mount 100, elongate body 102, and tail mount 104. Needle tail 78 includes spring shoulder 90, actuator shoulder 88, actuator groove 106. Inlet fitting 56 includes fitting sealing surface 108. Valve 58 is formed between ball 74 and seat 92.

Valve cartridge 24 is configured to mount to a handle assembly of a sprayer, such as a handle assembly formed by a gun body 12 and a handle 16. The valve cartridge 24 is configured as a self-contained fluid-handling cartridge that fully defines the fluid pathway between a supply hose and the outlet of valve 58. In the example shown, valve cartridge 24 does not include any self-contained biasing elements that actuate the valve 58 between the open and closed states. It is understood, however, that not all examples are so limited.

Valve cartridge is formed with three main exterior components, in the example shown, though it is understood that other numbers of exterior components can be used to form the exterior of the valve cartridge 24. In the example shown, the exterior components of valve cartridge 24 are formed by cartridge body 52 needle 54, and inlet fitting 56.

Cartridge body 52 contains elements that control release of paint from valve cartridge 24. In the example shown, cartridge body 52 is itself formed from three main exterior components, though it is understood that other numbers of exterior components can be used. The cartridge body 52 is formed by body housing 66, diffuser housing 64, and packing nut 68. The diffuser housing 64 and packing nut 68 are mounted to body housing 66 to form cartridge body 52. Diffuser housing 64 and body housing 66 define the fluid chamber 86 within cartridge body 52. Packing nut 68 extends into an annular cavity in body housing 66 and interfaces with packing seal 94 to support packing seal 94. Fluid inlet 72 extends through cartridge body 52. Cartridge body 52 can be formed from stainless steel, aluminum, or another type of metal, among other options.

Cartridge body 52 supports other components of valve cartridge 24. Diffuser housing 64 is mounted at one axial end of body housing 66. Diffuser housing 64 forms an axial-most portion of cartridge body 52 in first axial direction AD1. In the example shown, diffuser housing 64 forms an axial-most portion of valve cartridge 24 in first axial direction AD1. Cartridge outlet 70 is formed in diffuser housing 64, in the example shown. Seat 92 is supported by diffuser housing 64. Diffuser housing 64 extends into body housing 66. Diffuser housing 64 projects axially outward from body housing 66 in first axial direction AD1 such that diffuser housing 64 is disposed partially within body housing 66 and partially outside of body housing 66. In the example shown, diffuser seal 138 is disposed between cartridge body 52 and diffuser housing 64. Diffuser seal 138 is a fluid seal that prevents pressurized fluid from leaking between diffuser housing 64 and body housing 66. The diffuser seal 138 is disposed inside of cartridge body 52. Valve cartridge 24 does not include any exterior seals that are configured to seal between cartridge body 52 and gun body 12.

In some examples, diffuser housing 64 is configured with a diffuser sealing surface 112 that interfaces with a diffuser seating surface 114 formed within cartridge body 52. In the example shown, diffuser seating surface 114 is formed by the material forming cartridge body 52. Diffuser sealing surface 112 and diffuser seating surface 114 can be formed as flared surfaces. The flared diffuser sealing surface 112 and flared diffuser seating surface 114 can be formed as 37-degree flared surfaces, among other options. The flared interface facilitates sealing and reduces a hydraulic area within valve cartridge 24 to facilitate high pressure spraying (e.g., around or greater than about 5,000 psi (about 34.47 megapascal (MPa)).

Packing nut 68 is mounted at an opposite axial end of body housing 66 from diffuser housing 64. Packing nut 68 can also be referred to as a seal body. Packing nut 68 includes stem bore 116 through which the stem 76 of needle 54 extends. The radial width RW1 (distance between outer edges radially relative to the valve axis VA) of stem bore 116 is smaller than the radial width RW2 of ball mount 100 of stem 76 such that needle 54 cannot pass out of cartridge body 52 in second axial direction AD2. One or both of stem bore 116 and ball mount 100 can be cylindrical, such that the radial width RW1, RW2 can be diameters. Packing nut 68 is partially disposed within body housing 66 and projects outward from body housing 66. In the example shown, packing nut 68 extends to form an axial-most portion of cartridge body 52 in second axial direction AD2.

Packing nut 68 is directly connected to body housing 66 in the example shown. Specifically, the example shown includes packing nut 68 connected to body housing 66 by interfaced threading formed therebetween. Packing seal 94 is a fluid seal configured to seal the pressurized fluid chamber 86. Packing seal 94 is disposed within the cartridge body 52. Packing seal 94 is an internal fluid seal. Packing seal 94 is disposed within body housing 66. Packing seal 94 is axially supported by packing nut 68. Packing seal 94 extends around stem 76 and interfaces with stem 76. Packing seal 94 forms a fluid-tight seal with stem 76 and body housing 66. Packing seal 94 can be configured as a u-cup seal that is energized by the pressure of the spray fluid in the fluid chamber 86. The packing seal 94 forms a static seal with body housing 66 and sliding dynamic seal with stem 76.

Tip block 98 is formed at the outlet end 60 of cartridge body 52. In the example shown, tip block 98 is formed as a portion of body housing 66. Diffuser housing 64 extends into a portion of body housing 66 forming the tip block 98. Tip block 98 is configured to interface with tip mount 46 to mount the tip assembly 18 to the valve cartridge 24. In the example shown, tip block 98 is formed with threading configured to interface with threading on the tip mount 46. The tip block threads 118 are formed as exterior threading. In the example shown, the tip block threads 118 form a tip lock of the cartridge housing 52. The tip lock is configured to interface with an axial retainer to prevent axial displacement of the spray tip relative to the valve cartridge 24. In the example shown, the axial retainer is formed as a threaded ring of the tip mount 46.

Mount block 96 is formed at the mount end 62 of cartridge body 52. In the example shown, mount block 96 is formed as a portion of body housing 66. Packing nut 68 extends into the portion of body housing 66 forming the mount block 96 such that packing nut 68 radially overlaps with mount block 96. Packing seal 94 is disposed within the portion of body housing 66 forming the mount block 96 such that packing seal 94 radially overlaps with mount block 96.

Mount block 96 is configured to form a portion of the axial retaining interface that locks the valve cartridge 24 on the gun body 12. In the example shown, mount block 96 is formed with threading configured to interface with the threaded mount ring 22. The mount block threads 120 are formed as exterior threading. Mount block 96 projects radially outward from a central portion of body housing 66 that extends axially between tip block 98 and mount block 96.

Projection 122 is an axially projecting portion of cartridge body 52. Projection 122 extends from mount end 62 of cartridge body 52. Projection 122 is formed by and as a portion of the body housing 66 in the example shown. In the example shown, projection 122 extends from mount block 96. Projection 122 is disposed on an opposite axial side of mount block 96 from inlet fitting 56. Projection 122 is disposed on an opposite axial side of mount block 96 from fluid chamber 86. Projection 122 has a narrower radial width RW3 relative to spray axis SA than mount block 96 radial width RW4 and tip block 98 radial width RW5. Packing nut 68 is at least partially disposed within projection 122. In the example shown, packing nut 68 is threadedly connected to body housing 66 at a location within projection 122 such that the threaded interface retaining packing nut 68 radially overlaps with projection 122.

Cartridge lock 124 is configured to interface with a component of gun body 12 to rotationally lock cartridge valve 58 on gun body 12. In the example shown, cartridge lock 124 is formed on projection 122. Cartridge lock 124 is formed as an axial-most component of body housing 66. Cartridge lock 124 is formed as a shaped surface of projection 122. Cartridge lock 124 is configured to have an outer surface with a non-circular cross-sectional shape in a plane orthogonal to the valve axis VA. The non-circular cross-sectional shape of cartridge lock 124 prevents rotation of valve cartridge 24 about valve axis VA and relative to gun body 12. In the example shown, cartridge lock 124 is formed with four sides such that valve cartridge 24 can be mounted in any one of four discrete orientations relative to the gun body 12. For example, valve cartridge 24 can be mounted such that inlet fitting 56 is oriented vertically upward, vertically downward, laterally leftward, or laterally rightward. While cartridge lock 124 is shown as facilitating four-way mounting, it is understood that cartridge lock 124 can be configured to form as many or few orientations as desired, such as two, three, four, five, eight, or more orientations.

While cartridge lock 124 is shown as formed by an axial projection of cartridge body 52, it is understood that cartridge lock 124 can be formed in any desired manner suitable for interfacing with a component to rotationally lock cartridge body 52 relative to gun body 12. For example, cartridge lock 124 can be formed as a toothed interface between cartridge body 52 and sprayer 10; cartridge lock 124 can be formed by sets of one or more projections and bores formed in the cartridge body 52 and gun body 12, which mating sets can be radially offset from the spray axis SA; among other options. For example, one or more pegs can project from the axial face of mount block 96 that is oriented in second axial direction AD2. The pegs can interface with bores formed in front end 28 of gun body 12 to rotationally lock the valve cartridge 24 relative to the gun body 12. The bores can be arranged in one or more sets about the spray axis SA to facilitate rotationally locking valve cartridge 24 in different orientations.

Cartridge lock 124 is formed as an anti-rotation lock. Cartridge lock 124 interfaces with a component of sprayer 10, such as gun body 12, to prevent rotation of valve cartridge 24 about valve axis VA and relative to gun body 12. Mount block 96 is formed as an anti-axial displacement lock. Mount block 96 is configured to interface with a component of gun body 12 to prevent axial displacement of valve cartridge 24 relative to gun body 12 along the valve axis VA. Tip block 98 is formed as an anti-axial displacement lock. Tip block 98 interfaces with tip mount 46 to prevent axial displacement of tip assembly 18 relative to valve cartridge 24 along valve axis VA.

Body housing 66 at least partially defines fluid chamber 86. Spray fluid pressurizes the fluid chamber 86 during spray operations utilizing the valve cartridge 24. Inlet fitting 56 is mounted to cartridge body 52. Inlet fitting 56 is configured to mount to a supply line, such as a hose, to provide spray fluid to valve cartridge 24 under pressure. Fitting 56 includes a first end interfacing with cartridge body 52 and a second end configured to interface with a hose assembly to receive flows of spray fluid from the hose of the hose assembly. In some examples, fitting 56 is configured with a fitting sealing surface 108 that interfaces with a fitting seating surface 110 formed within cartridge body 52. In the example shown, fitting seating surface 110 is formed by the material forming cartridge body 52. Fitting sealing surface 108 and fitting seating surface 110 can be formed as flared surfaces. The flared fitting sealing surface 108 and flared fitting seating surface 110 can be formed as 37-degreed flared surfaces, among other options. The flared interface facilitates sealing and reduces a hydraulic area within valve cartridge 24 to facilitate high pressure spraying (e.g., around or greater than about 5,000 psi (about 34.47 MPa).

Needle 54 is disposed at least partially within the cartridge body 52. Needle includes a sealing end 126 disposed within the fluid chamber 86 and an actuation end 128 disposed outside of the spray fluid flowpaths through valve cartridge 24. Ball 74 is disposed at the sealing end 126. Ball 74 forms a component of valve 58. Ball 74 engages with seat 92 with valve 58 in the closed state. Ball 74 is disengaged from seat 92 with valve 58 in the open state. Ball 74 is mounted to stem 76, such as by welding, brazing, press-fitting, etc. Ball mount 100 is a portion of stem 76 that ball 74 is mounted on. Ball mount 100 has a ball radial width RW2. The radial width RW2, which can be a diameter, is larger than a radial width RW6 of the elongate body 102 of stem 76, which can be a diameter. Ball mount 100 can also be referred to as a seal holder. In the example shown, ball mount 100 is formed unitarily with other portions of stem 76 (e.g., as a single piece of material), though it is understood that not all examples are so limited. For example, ball mount 100 could be formed separately and mounted over a portion of stem 76, such as by a set screw among other connectors.

Stem 76 is formed such that the diameter of stem 76 transitions between elongate body 102 and ball mount 100 at valve end transition 130. The valve end transition 130 is formed as a sloped shoulder that slopes between the larger width ball mount 100 and the smaller width elongate body 102. In some examples, ball mount 100 is formed as a cylindrical body portion. In some examples, elongate body 102 is formed as a cylindrical body portion. The valve end transition 130 between ball mount 100 and elongate body 102 is formed within the fluid chamber 86. The transition is not formed within any dry areas of valve cartridge 24 or sprayer 10. The valve end transition 130 is formed on a portion of stem 76 that is located axially between seat 92 and packing seal 94 with valve 58 in both the open state and the closed state. The width RW2 of the ball mount 100 is larger than the central opening through packing seal 94 and the width RW1 of the stem bore 116 through packing nut 68. The larger width ball mount 100 and smaller width passages prevent needle 54 from passing out of cartridge body 52 in second axial direction AD2.

Stem bore 116 through packing nut 68 is sized to interface with stem 76 to align needle 54 on valve axis VA. Packing nut 68 can be considered to form an aligning component of valve 58 that axially aligns needle 54, and thus ball 74, with seat 92. Packing nut 68 supporting stem 76 can assist in aligning valve axis VA coaxial with spray axis SA during mounting and dismounting of valve cartridge 24.

Elongate body 102 extends through packing seal 94 and packing nut 68 from inside of the fluid chamber 86 and within cartridge body 52, to outside of cartridge body 52 and into dry portions of valve cartridge 24.

Needle 54 interfaces with biasing components to displace needle 54 along valve axis VA. Stem 76 is configured to transmit forces from at least one of the biasing components that drives needle 54 along valve axis VA. In the example shown, needle tail 78 is mounted to stem 76. Needle tail 78 can also be referred to as a slider. Needle tail 78 is configured to interface with the biasing components of sprayer 10 to transmit forces to stem 76 and displace ball 74 axially relative to seat 92. Needle tail 78 is mounted to tail mount 104 of stem 76. In the example shown, needle tail 78 is connected to stem 76 by a threaded interface between needle tail 78 and stem 76. The threading can be formed at the distal end of stem 76 opposite the ball 74. Needle tail 78 engages stem 76 by a threaded interface at tip mount 46.

Tip mount 46 has a radial width RW7, which can be a diameter, that is smaller than the radial width RW6 of the elongate body 102. Stem 76 includes a needle end transition 132 formed between the elongate body 102 and tip mount 46. Needle end transition 132 is formed as a tapered or sloped transition in the example shown. Needle end transition 132 extends both radially and axially relative to valve axis VA. Needle end transition 132 changes the width of the stem 76 at a location axially between tail mount 104 and cartridge body 52. Needle tail 78 engages stem 76 at needle end transition 132. The interface between needle tail 78 and needle end transition 132 is formed such that needle tail 78 can transmit forces to stem 76 at the interface.

Needle tail 78 includes tail transition 134 that interfaces with needle end transition 132. The interface is configured such that needle tail 78 transmits axial displacement forces to stem 76 at the interface between the surfaces forming tail transition 134 and needle end transition 132. In the example shown, tail transition 134 is a sloped portion of the bore through needle tail 78. Tail transition 134 reduces in diameter as needle tail 78 extends in second axial direction AD2. Tail transition 134 can also be referred to as a shoulder. The surface forming tail transition 134 is configured as a mating surface to the surface forming needle end transition 132. The mating surfaces can be configured for a tight fit that is formed fully annularly about the valve axis VA. The tail transition 134 can be formed extending radially between tail mount 104 and elongate body 102. Tail transition 134 can be referred to as a shoulder. In the example shown, tail transition 134 is formed as a sloped exterior surface of the needle 54.

In the example shown, tail mount 104 interfaces with needle tail 78 at a location radially overlapping with locating stud 136 of needle tail 78. The locating stud 136 has a reduced radial width, which can be a diameter, relative to the portion of needle tail 78 forming spring shoulder 90. The locating stud 136 is configured to extend into the spring cap 84, which axially aligns the spring assembly 26 and needle 54. The threaded interface between stem 76 and needle tail 78 is fully or substantially located on an opposite axial side of the force transition surfaces (spring shoulder 90, actuator shoulder 88, needle end transition 132, and tail transition 134) of needle 54 from the valve 58. The spring assembly 26 does not transmit forces through the threaded interface between stem 76 and needle tail 78 due to the positioning of the connection between needle tail 78 and stem 76 relative to the force transition surfaces. Instead, the forces are transmitted through the more resilient interface between tail transition 134 and needle end transition 132, providing a robust assembly and protecting the connection between needle tail 78 and stem 76.

Actuator groove 106 is formed on the exterior of needle tail 78. Actuator shoulder 88 is formed at one end of the actuator groove 106. The actuator shoulder 88 is configured to interface with the actuator 42 such that trigger 14 can actuate needle 54 in the second axial direction AD2. It is understood, however, that not all examples are so limited. For example, needle 54 can be connected to a trigger by a pinned interface or other interface suitable for transmitting forces between trigger 14 and needle 54.

In the example shown, the drive portions of needle 54 that interface with the biasing components (actuator shoulder 88 and spring shoulder 90) are formed as dry components that are not exposed to the spray fluid flowing through valve cartridge 24. The drive portions of needle 54 are disposed on a same axial side of the cartridge body 52 and are not disposed within cartridge body 52. The mounting interfaces of valve cartridge 24 (e.g., at tip block 98, mount block 96, and cartridge lock 124) are grouped such that no drive portion is disposed axially between the mounting interfaces. The drive portions are grouped such that no mounting interface is disposed axially between the drive portions.

Needle 54 is configured to shift axially along the valve axis VA to actuate valve 58 between the open state and closed state. The valve axis VA can be coaxial with the spray axis SA during operation. Needle 54 shifts in second axial direction AD2 to disengage ball 74 from seat 92 and open the flowpath through valve 58. Needle 54 shifts in first axial direction AD1 to engage ball 74 with seat 92 and close the flowpath through valve 58.

Valve cartridge 24 is mountable to and dismountable from the gun body 12 as a single unitary component. The unitary valve cartridge 24 fully contains the fluid pathways of a sprayer that the valve cartridge 24 is mounted to. The valve 58, which is the spray control valve of the sprayer 10, is formed within valve cartridge 24. As such, the valve 58 is replaced every time the valve cartridge 24 is swapped on a sprayer 10. Replacing the valve 58 allows the valve 58 to be dedicated to a single type of spray fluid, if desired, eliminating any risk of cross-contamination.

Diffuser housing 64 and/or packing nut 68 can be torqued to body housing 66 to such a degree as to not allow a user to unthread the interfaces between diffuser housing 64 and body housing 66 and between packing nut 68 and body housing 66 by hand (or even with conventional tools). Additionally or alternatively, adhesive can be added to threaded interfaces of valve cartridge 24 to prevent unthreading by a user. While threading is used as an example, it is understood that diffuser housing 64, body housing 66, and packing nut 68 can be fixed together in any desired manner. Similarly, inlet fitting 56 can be torqued to cartridge body 52 to such a degree as to not allow a user to unthread the interface between inlet fitting 56 and cartridge body 52. Additionally or alternatively, adhesive can be added to threaded interfaces between inlet fitting 56 and cartridge body 52 to prevent unthreading by a user. While threading is used as an example, it is understood that cartridge body 52 and inlet fitting 56 can be fixed together in any desired manner.

Valve cartridge 24 fully contains the fluid conveying components between the hose and the spray tip 48. Valve cartridge 24 can be removed as a single component and replaced as a single component. Valve cartridge 24 can be mounted by axial movement of the valve cartridge 24 relative to the gun body 12 and along the valve axis VA. Cartridge lock 124 inhibits rotation of the valve cartridge 24 about the valve axis VA while valve cartridge 24 is mounted to gun body 12. Mount threads 120 form a portion of a threaded interface that axially retains valve cartridge 24 on gun body 12. The anti-rotation interface allows fitting 56 to be positioned at various radial orientations extending away from the valve axis VA. The anti-rotation interface allows for fitting 56 to be positioned at a desired orientation to facilitate ergonomic and efficient operation of sprayer 10.

Valve cartridge 24 can be quickly and simply mounted on and removed from a gun body 12. Replacing valve cartridge 24 replaces the spray control valve 58 of the sprayer 10. Valve cartridge 24 is an only fluid-handling component of the sprayer 10 that is connected to the gun body 12. Disconnecting valve cartridge 24 from gun body 12 removes all fluid-handling components from the user-handled components of sprayer (e.g., handle 16, gun body 12, and trigger 14). Valve cartridge 24 is a unitary fluid-handling component that is mountable to and dismountable from gun body 12 without disassembly or disconnection of any components of valve cartridge 24.

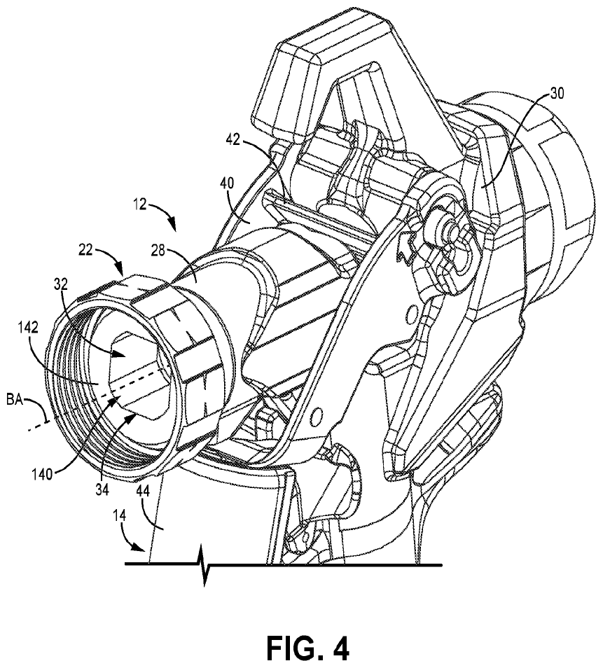

FIG. 4 is an isometric view of gun body 12. Front end 28 and back end 30 of gun body 12 are shown. Mount bore 34 is formed in front end 28. Spring bore 36 is formed in back end 30. Mount bore 34 and spring bore 36 are disposed coaxially on bore axis BA. The mount bore 34 and spring bore 36 together define gun bore 32 that extends fully through gun body 12 along bore axis BA. Void 38 is disposed between mount bore 34 and spring bore 36 along bore axis BA.

Valve cartridge 24 is partially disposed within mount bore 34 and partially disposed within spring bore 36 with valve cartridge 24 mounted to gun body 12. Specifically, cartridge body 52 is partially disposed within mount bore 34 and needle 54 extends through mount bore 34 and into spring bore 36. No portion of cartridge body 52 extends into void 38 or spring bore 36. The cartridge body 52 does not extend a full axial length of mount bore 34.

Mount lock 140 is formed in gun body 12. Mount lock 140 is configured to interface with valve cartridge 24 to prevent rotation of valve cartridge 24 on bore axis BA and relative to gun body 12. In the example shown, mount lock 140 is formed by a portion of gun body 12. Specifically, mount lock 140 is formed as a contoured surface of mount bore 34. Mount lock 140 is formed as a distal portion of mount bore 34 in first axial direction AD1, in the example shown. In the example shown, the mount lock 140 is a contoured surface configured to interface with the contoured surface of cartridge lock 124. While mount lock 140 is shown as a contoured bore, it is understood that mount lock 140 can be of any configuration suitable for interfacing with cartridge body 52 to prevent rotation of cartridge body on bore axis BA and relative to gun body 12.

In some examples, mount lock 140 is formed as a projection extending from gun body 12 and configured to interface with a bore in cartridge body 52. For example, mount lock 140 can be formed as one or more posts extending axially relative to bore axis BA and spaced radially outward from gun bore 32. The valve cartridge 24 can include an array of bores to facilitate mounting of valve cartridge 24 in multiple clock orientations about the bore axis BA.

In some examples, including the example shown, mount lock 140 is formed as a recess formed in gun body 12 and configured to interface with a projection of cartridge body 52. For example, mount lock 140 can be formed as an array of bores extending into gun body 12. The bores can extend into the of the front end 28 of gun body 12. The valve cartridge 24 can include one or more projections configured to mate with the bores to facilitate rotationally locking valve cartridge 24 and, in some examples, facilitate mounting of valve cartridge 24 in multiple clock orientations about the bore axis BA.

In some examples, mount lock 140 is formed as an array of teeth about the bore axis BA. For example, a toothed ring can be formed about the gun bore 32 on the face 142 of front end 28 with the teeth extending axially. The toothed ring face can mate with a toothed ring face on the valve cartridge 24 to rotationally locate the valve cartridge 24 about the bore axis BA. The axial retaining interface pulls valve cartridge 24 onto gun body 12 to secure the toothed faces and rotationally lock valve cartridge 24 on gun body 12.

It is understood, however, that the mount lock 140 can be of any configuration suitable for inhibiting rotation of valve cartridge 24 relative to gun body 12. Mount lock 140 facilitates mounting of valve cartridge 24 to gun body 12 in multiple positions and maintaining the position of the valve cartridge 24 relative to gun body 12. In the example shown, the mount lock 140 includes four flat surfaces such that valve cartridge 24 can be mounted in four different orientations. In the example shown, the valve cartridge 24 can be mounted such that inlet fitting 56 is vertically downward, vertically upward, laterally left, or laterally right.

Gun body 12 is configured as a dry component of a spray gun assembly. The gun body 12 does not include or define spray fluid transmission pathways. In the example shown, gun body 12 does not include passages that transmit spray fluid (e.g., paint) or compressed air. The gun body 12 connects to the fluid carrying component(s) of the sprayer 10 (e.g., the valve cartridge 24).

Valve cartridge 24 includes a component (e.g., cartridge lock 124 on projection 122) that extend into mount bore 34. The valve cartridge 24 interfaces with gun body 12 at mount lock 140 to rotationally lock the valve cartridge 24 to gun body 12. The valve cartridge 24 is clamped onto gun body 12 by an axial retaining interface. In the example shown, the front end 28 of gun body 12 is configured to support a threaded ring (e.g., mount ring 22 (FIGS. 1 and 2)) that connects to mount block threading 120 on cartridge body 52. It is understood that, in some examples, the threaded ring 22 can be supported on valve cartridge 24 and gun body 12 can include threads configured to interface with the threaded ring. For example, the exterior surface of front end 28 can include threading configured to interface with the threading of the threaded ring, thereby axially securing the valve cartridge 24 on gun body 12.

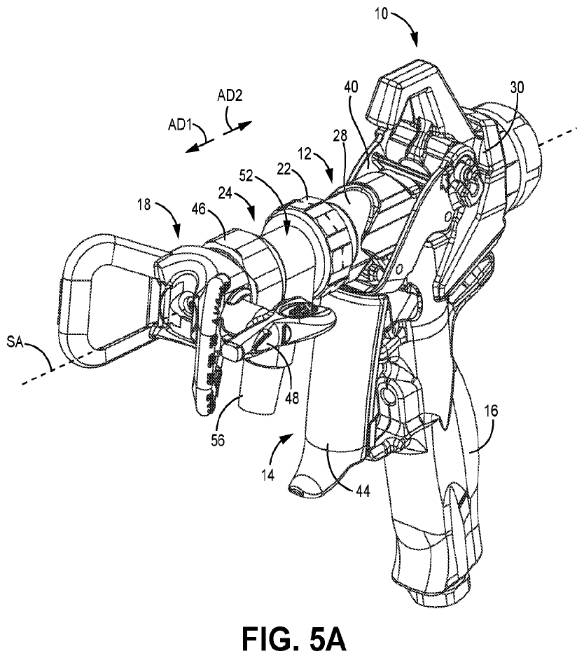

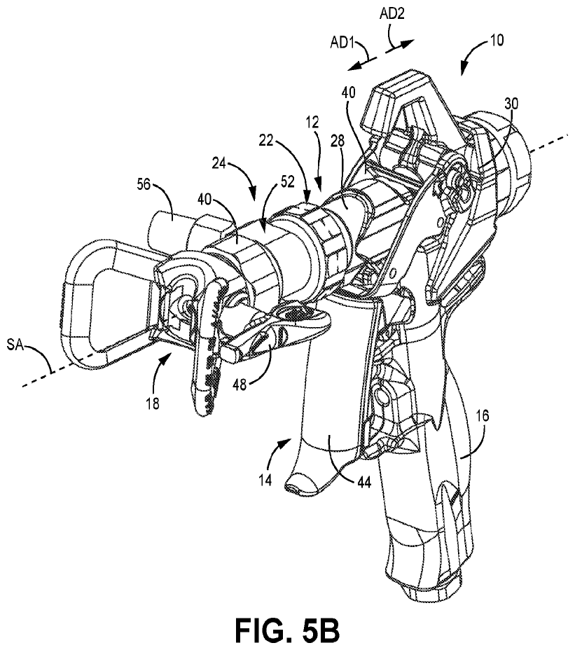

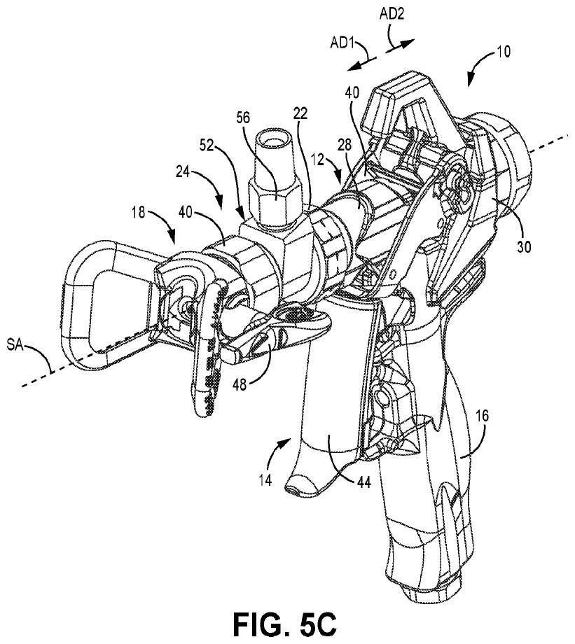

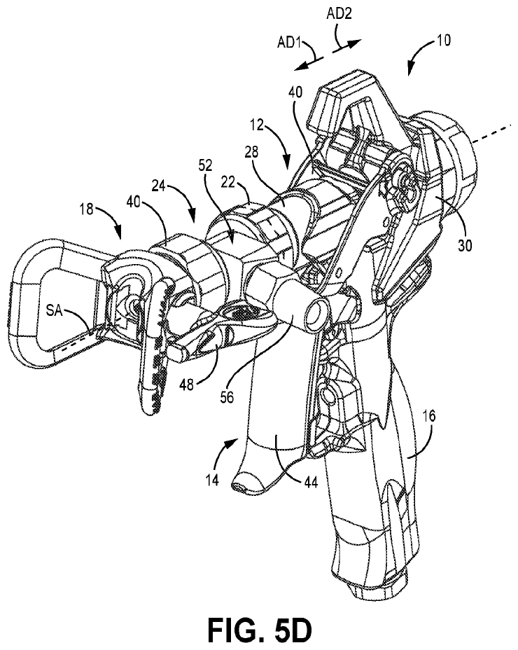

FIG. 5A is a first isometric view of sprayer 10 showing valve cartridge 24 mounted in a first position. FIG. 5B is a second isometric view of sprayer 10 showing valve cartridge 24 mounted in a second position. FIG. 5C is a third isometric view of sprayer 10 showing valve cartridge 24 mounted in a third position. FIG. 5D is a fourth isometric view of sprayer 10 showing valve cartridge 24 mounted in a fourth position.

The valve cartridge 24 is mountable to the gun body 12 in multiple orientations. Valve cartridge 24 is reorientable such that fitting 56 extends in multiple different directions relative to the gun body 12. The valve cartridge 24 can be mounted in the various positions to satisfy user preference and to provide for ergonomic spraying by the user. The valve cartridge 24 can be mounted in the various positions to facilitate efficient spraying regardless of the position of the supply pump relative to the sprayer 10. For example, the user may be below the supply pump while spraying in a manhole or at other locations. Gun body 12 includes mount lock 140 that interfaces with valve cartridge 24 to rotationally lock the valve cartridge 24 on the gun body 12.

While sprayer 10 is described as being reconfigurable by reorienting a valve cartridge relative to a gun body, it is understood that not all examples are so limited. Sprayer 10 includes a second housing (e.g., valve cartridge 24) that is mountable to a first housing (e.g., gun body 12) in multiple orientations. The fitting 56 extends outward from the second housing. The multiple mounting configurations facilitate positioning fitting 56 at different orientations relative to the first housing. The fitting 56 can thus be positioned at the ideal orientation for one particular spray job and reoriented as desired for other spray jobs. The second housing is not necessarily a valve cartridge and some examples may not contain a valve (e.g., valve 58). The first housing is not necessarily a gun body but may instead be an intermediate housing supported by a separate body connected to a handle, among other options.

In the first position shown in FIG. 5A, the valve cartridge 24 is positioned such that inlet fitting 56 projects downward. The inlet fitting 56 can be aligned with the handle 16. The valve cartridge 24 is positioned such that the inlet fitting 56 is at a 6 o'clock position when looking along spray axis SA in first axial direction AD1. The position of inlet fitting 56 can be changed by dismounting valve cartridge 24 from gun body 12, rotating valve cartridge 24 relative to gun body 12, and reconnecting valve cartridge 24 in a new clock position.

In the second position shown in FIG. 5B, the valve cartridge 24 is positioned such that inlet fitting 56 projects laterally. Specifically, the inlet fitting 56 projects laterally relative to the right lateral side of gun body 12. The valve cartridge 24 is positioned such that the inlet fitting 56 is at a 3 o'clock position when looking along spray axis SA in the first axial direction AD1.

In the third position shown in FIG. 5C, the valve cartridge 24 is positioned such that inlet fitting 56 projects vertically upward. Specifically, the inlet fitting 56 projects vertically from an opposite side of gun body 12 from which the handle 16 projects vertically. The inlet fitting 56 projects in an opposite vertical direction from the handle 16 in this example. The inlet fitting 56 is aligned with the hook of the gun body 12, which hook can be used to hang sprayer 10. The valve cartridge 24 is positioned such that the inlet fitting 56 is at a 12 o'clock position when looking along spray axis SA in the first axial direction AD1.

In the fourth position shown in FIG. 5D, the valve cartridge 24 is positioned such that inlet fitting 56 projects laterally. Specifically, the inlet fitting 56 projects laterally relative to the left lateral side of gun body 12. The valve cartridge 24 is positioned such that the inlet fitting 56 is at a 9 o'clock position when looking along spray axis SA in the first axial direction AD1. As shown, tip assembly 18 can remain in a same orientation regardless of the orientation of valve cartridge 24. In the example shown, spray tip 48 extends to the lateral left with valve cartridge 24 mounted in each of the four positions shown in FIGS. 5A-5D.

Valve cartridge 24 and gun body 12 forming sprayer 10 provides significant advantages. Valve cartridge 24 can be positioned at various rotational positions about the spray axis SA to position the inlet fitting 56 in a position as needed. While valve cartridge 24 is shown as being positionable in four distinct positions, the valve cartridge 24 and gun body 12 can be configured to mate such that valve cartridge 24 is disposed at any desired orientation relative to the spray axis SA (e.g., two, three, four, six, eight, twelve, or more orientations). Such a multiple mounting configuration allows a single valve cartridge 24 to be mounted on a single gun body 12 to provide multiple different configurations of a sprayer.

### Discussion of Non-Exclusive Examples

The following are non-exclusive descriptions of possible examples of the present invention.

A paint spray gun includes a gun body, a valve cartridge removably secured to the gun body, and a trigger attached to the gun body and structured to actuate the valve cartridge. The gun body interfaces with the valve cartridge at an anti-rotation interface that prevents rotation of the valve cartridge when attached to the gun body.

The spray gun of the preceding paragraph can optionally include, additionally and/or alternatively, any one or more of the following features, configurations and/or additional components:

At least one engagement member formed on at least one of the gun body and the valve cartridge, the at least one engagement member forming at least a portion of the anti-rotation interface.

The anti-rotation interface is formed by a projection extending into a receiver.

The projection is aligned with a spray axis of the spray gun.

The projection is radially offset from a spray axis of the spray gun.

The valve cartridge includes the projection and the gun body includes the receiver.

The valve cartridge includes the projection, the gun body includes the receiver, and the projection is configured to mate with the receiver at multiple relative positions.

The valve cartridge is configured to output spray fluid at an outlet end of a cartridge body of the valve cartridge and the projection is disposed at a mount end of the cartridge body, the mount end opposite the outlet end.

The valve cartridge includes a needle partially within the cartridge body and partially outside of the cartridge body, the needle configured to control flow of the spray fluid downstream from the valve cartridge, the needle extending through the projection.

The projection includes a plurality of flat surfaces and the recess includes a plurality of flat surfaces configured to interface with the plurality of flat surfaces of the projection to prevent relative rotation between the valve cartridge and the gun body.

The multiple relative positions includes at least two relative positions.

The multiple relative positions includes at least four relative positions.

The multiple relative positions includes at least eight relative positions.

The multiple relative positions includes a first position in which an inlet fitting of the valve cartridge projects vertically relative to the gun body and a second position in which the inlet fitting projects laterally relative to the gun body.

The valve cartridge includes a cartridge body interfacing with the gun body at the anti-rotation interface, a needle partially disposed within the cartridge body and partially disposed outside of the cartridge body, and a fluid inlet of the cartridge body is disposed outside of a gun bore within the gun body.

An inlet fitting connected to the cartridge body and projecting outward from the cartridge body.

The inlet fitting is connected to the fluid inlet of the cartridge body.

The needle interfaces with a spring assembly supported by the gun body and the needle interfaces with a trigger supported by the gun body with the valve cartridge mounted on gun body.

The needle interfaces with the spring assembly such that the spring assembly biases the needle in a first axial direction along the valve axis to close a valve of the valve cartridge.

No spring is disposed within a fluid flowpath of the valve cartridge.

The gun body does not include a spray fluid pathway within the gun body.

The spray fluid does not flow within the gun body.

A paint spray gun includes a gun body having a gun bore formed therein and a valve cartridge mountable to and dismountable from the gun body, the valve cartridge configured to connect to a hose supplying spray fluid to the paint spray gun, the valve cartridge including a valve within the valve cartridge, the valve configured to be actuated between an open state and a closed state. The valve cartridge is at least partially disposed within the gun body and a fluid inlet of the valve cartridge is disposed outside of the gun body with the valve cartridge mounted to the gun body.

The paint spray gun of the preceding paragraph can optionally include, additionally and/or alternatively, any one or more of the following features, configurations and/or additional components:

The valve cartridge interfaces with the gun body at an anti-rotation interface that prevents rotation of the valve cartridge relative to the gun body.

The valve cartridge includes an inlet fitting mounted to a cartridge body.

The valve cartridge includes a needle partially within the cartridge body and elongate along a valve axis.

A first end of the needle is disposed within the cartridge body and a second end of the needle is disposed outside of the cartridge body.

A ball is mounted at the first end of the needle.

The needle includes an axially elongate stem, a ball mounted to a first end of the stem, and a needle tail mounted to a second end of the stem.

The cartridge body includes an axial projection extending into the gun bore.

The valve cartridge interfaces with the gun body at an axial retention interface that prevents axial movement of the valve cartridge relative to the gun body.

The axial retention interface is a threaded interface.

The threaded interface is formed between a threaded ring supported by the gun body and threading formed on the valve housing.

The threading is exterior threading and the threaded ring includes interior threading.

A tip mount is connected to the valve cartridge, the tip mount supporting a spray tip.

The spray tip is a reversible spray tip.

The tip mount is connected to the valve cartridge by a tip threaded interface.

The tip threaded interface includes exterior threading formed on the cartridge body.

The valve cartridge interfaces with the gun body at an anti-rotation interface that prevents rotation of the valve cartridge relative to the gun body, the valve cartridge interfaces with the gun body at an axial retention interface that prevents axial movement of the valve cartridge relative to the gun body, and the axial retention interface is disposed on an opposite axial side of the anti-rotation interface from the fluid inlet.

A valve cartridge for a paint spray gun, the valve cartridge includes a cartridge body includes an outlet end having a cartridge outlet therethrough, a mount end, and a fluid inlet extending through the cartridge body from an exterior of the cartridge body to a fluid chamber formed within the cartridge body, the fluid inlet disposed between the outlet end and the mount end. A valve disposed within the cartridge body and configured to control flow of the paint from the fluid chamber through the cartridge outlet.

The valve cartridge of the preceding paragraph can optionally include, additionally and/or alternatively, any one or more of the following features, configurations and/or additional components:

First threads disposed at the mount end of the cartridge body, the first threads configured to form a portion of a mounting interface that axially secures the cartridge body to a gun body of the paint spray gun.

Second threads disposed at the outlet end of the cartridge body.

An inlet fitting connected to the cartridge body and projecting outward from the cartridge body.

The inlet fitting extends radially outward relative to a valve axis of the valve.

The inlet fitting extends axially relative to the valve axis.

The inlet fitting mounts to the cartridge body at a flared interface.

The inlet fitting mounts to the cartridge body at a fitting threaded interface.

A needle partially disposed in the cartridge body and extending out from the cartridge body through the mount end.

A seat supported by the cartridge body and a ball supported by the needle, the ball configured to mate with the seat with the valve in a closed state, and the ball configured to be spaced from the seat with the valve in an open state.

The ball is mounted on a stem of the needle, the stem extending out of the cartridge body.

The stem includes a ball mount having a first radial width, the stem includes a body portion having a second radial width, the first radial width is larger than the second radial width, the ball is mounted on the ball mount, and the body portion extends out of the cartridge body.

The stem further includes a tail mount having a third radial width, the third radial width smaller than the second radial width.

A needle tail mounted on the stem, the needle tail configured to interface with a needle displacer of the paint spray gun to cause the ball to displace relative to the seat along the valve axis.

An axial projection, the tail mount radially overlapping with the axial projection and a spring shoulder extending radially outward relative to the axial projection.

The spring shoulder is spaced axially from the tail mount.

The needle tail is mounted on the tail mount by a tail threaded interface.

The tail mount includes exterior threading and the needle tail includes interior threading.

The stem includes a tail transition between the body portion and the tail mount, the tail transition having a sloped exterior surface.

The cartridge body further includes a body housing, a diffuser housing mounted to a first end of the body housing, and a packing nut mounted to a second end of the body housing opposite the first end.

A needle partially disposed in the cartridge body and extending outward from the cartridge body through the mount end, a seat supported by the cartridge body, and a ball supported by the needle, the ball configured to mate with the seat with the valve in a closed state, and the ball configured to be spaced from the seat with the valve in an open state.

A stem of the needle extends through a bore formed in the packing nut.

A packing seal disposed within the body housing, the packing nut axially supporting the packing seal, and the packing seal engaging the needle to form a sliding fluid seal.

The packing seal includes a lip configured to be energized by fluid pressure of the spray fluid.

The packing seal is a u-cup seal.

The body housing includes a cartridge lock shaped to interface with a gun body of the paint spray gun to prevent rotation of the of the cartridge body about the valve axis and relative to the gun body.

The cartridge lock is formed as a contoured surface of the body housing.

The body housing includes an axial projection, the cartridge lock formed by the axial projection.

The axial projection is disposed coaxially with the valve axis.

The axial projection is disposed such that the valve axis passes through the cartridge lock.

The axial projection is spaced radially from the valve axis.

The body housing includes a mount lock shaped to interface with an axial retainer to prevent axial displacement of the cartridge body relative to the gun body.

The mount lock is formed by threading formed on an exterior of the body housing.

The mount lock includes a threaded surface.

The body housing includes a tip lock shaped to interface with an axial retainer to prevent axial displacement of a spray tip relative to the valve cartridge.

The tip lock includes threading formed on an exterior of the body housing.

The tip lock includes a threaded surface.

The mount lock is formed by first threading on the body housing, the tip lock is formed by second threading on the body housing, and the fluid inlet is disposed between the first threading and the second threading.

The cartridge body does not include a seal mounted on an exterior of the cartridge body.

The cartridge body does not include a seal groove extending into an exterior of the cartridge body.

A valve cartridge for a paint spray gun, the valve cartridge includes a cartridge body includes an outlet end having a cartridge outlet therethrough, a mount end, and a fluid inlet extending through the cartridge body from an exterior of the cartridge body to a fluid chamber formed within the cartridge body, the fluid inlet disposed between the outlet end and the mount end. A valve disposed within the cartridge body and configured to control flow of the paint from the fluid chamber through the cartridge outlet and a needle partially disposed within the cartridge body and extending out of the cartridge body through the mount end, the needle movable along a valve axis to actuate the valve between an open state and a closed state.

A valve cartridge for a paint spray gun, the valve cartridge includes a cartridge body including an outlet end having a cartridge outlet therethrough, a mount end, and a fluid inlet extending through the cartridge body from an exterior of the cartridge body to a fluid chamber formed within the cartridge body, the fluid inlet disposed between the outlet end and the mount end. A valve disposed within the cartridge body and configured to control flow of the paint from the fluid chamber through the cartridge outlet, a needle partially disposed within the cartridge body and extending out of the cartridge body through the mount end, the needle movable along a valve axis to actuate the valve between an open state and a closed state, and an inlet fitting connected to the cartridge body and projecting radially outward relative to the valve axis.

A valve cartridge for a paint spray gun, the valve cartridge includes a cartridge body includes an outlet end having a cartridge outlet therethrough, a mount end, a body housing, a diffuser housing mounted to a first end of the body housing, and a packing nut mounted to a second end of the body housing opposite the first end. A fluid inlet extending through the cartridge body from an exterior of the cartridge body to a fluid chamber formed within the cartridge body, the fluid inlet disposed between the outlet end and the mount end, and a valve disposed within the cartridge body and configured to control flow of the paint from the fluid chamber through the cartridge outlet. A needle partially disposed within the cartridge body and extending out of the cartridge body through the mount end, the needle movable along a valve axis to actuate the valve between an open state and a closed state, and an inlet fitting connected to the cartridge body and projecting radially outward relative to the valve axis.

A valve cartridge for a paint spray gun, the valve cartridge includes a cartridge body including an outlet end having a cartridge outlet therethrough, a mount end, a fluid inlet extending through the cartridge body from an exterior of the cartridge body to a fluid chamber formed within the cartridge body, the fluid inlet disposed between the outlet end and the mount end, a cartridge lock shaped to interface with a gun body of the paint spray gun to prevent rotation of the of the cartridge body about the valve axis and relative to the gun body, a mount lock shaped to interface with an axial retainer to prevent axial displacement of the cartridge body relative to the gun body, and a tip lock shaped to interface with an axial retainer to prevent axial displacement of a spray tip relative to the valve cartridge. A valve disposed within the cartridge body and configured to control flow of the paint from the fluid chamber through the cartridge outlet and a needle partially disposed within the cartridge body and extending out of the cartridge body through the mount end, the needle movable along a valve axis to actuate the valve between an open state and a closed state.

The valve cartridge of the preceding paragraph can optionally include, additionally and/or alternatively, any one or more of the following features, configurations and/or additional components:

An inlet fitting connected to the cartridge body and projecting radially outward relative to the valve axis.

The cartridge lock is shaped such that the valve cartridge can interface with the gun body to prevent relative rotation with the fluid inlet oriented a plurality of radial directions about the valve axis.

The mount lock and the tip lock are disposed on opposite axial sides of the fluid inlet.

The mount lock is disposed on a same axial side of fluid inlet as the cartridge lock.

The mount lock and the cartridge lock are disposed on an opposite axial side of the fluid inlet from the cartridge outlet.

A valve cartridge for a paint spray gun, the valve cartridge includes a cartridge body includes an outlet end having a cartridge outlet therethrough, a mount end, a fluid inlet extending through the cartridge body from an exterior of the cartridge body to a fluid chamber formed within the cartridge body, the fluid inlet disposed between the outlet end and the mount end, and a cartridge lock shaped to interface with a gun body of the paint spray gun to prevent rotation of the of the cartridge body about the valve axis and relative to the gun body. A valve disposed within the cartridge body and configured to control flow of the paint from the fluid chamber through the cartridge outlet and a needle partially disposed within the cartridge body and extending out of the cartridge body through the mount end, the needle movable along a valve axis to actuate the valve between an open state and a closed state.

The valve cartridge of the preceding paragraph can optionally include, additionally and/or alternatively, any one or more of the following features, configurations and/or additional components:

A mount lock shaped to interface with an axial retainer to prevent axial displacement of the cartridge body relative to the gun body.

A tip lock shaped to interface with an axial retainer to prevent axial displacement of a spray tip relative to the valve cartridge.

A valve cartridge for a paint spray gun, the valve cartridge includes a cartridge body including an outlet end having a cartridge outlet therethrough, a mount end, a fluid inlet extending through the cartridge body from an exterior of the cartridge body to a fluid chamber formed within the cartridge body, the fluid inlet disposed between the outlet end and the mount end, and a mount lock shaped to interface with an axial retainer to prevent axial displacement of the cartridge body relative to the gun body. A valve disposed within the cartridge body and configured to control flow of the paint from the fluid chamber through the cartridge outlet and a needle partially disposed within the cartridge body and extending out of the cartridge body through the mount end, the needle movable along a valve axis to actuate the valve between an open state and a closed state.

The valve cartridge of the preceding paragraph can optionally include, additionally and/or alternatively, any one or more of the following features, configurations and/or additional components:

A cartridge lock shaped to interface with a gun body of the paint spray gun to prevent rotation of the of the cartridge body about the valve axis and relative to the gun body.

A tip lock shaped to interface with an axial retainer to prevent axial displacement of a spray tip relative to the valve cartridge.

A paint spray gun includes a gun body defining a gun body and the valve cartridge mountable within the gun bore such that the fluid inlet is disposed outside of the gun bore.

A paint spray gun includes a gun body supporting a trigger, a gun bore extending at least partially through the gun body, a valve cartridge configured to interface with the gun body by axial movement of the valve cartridge along the gun axis, the valve cartridge interfacing with the gun body such that the valve cartridge can support or be supported by the gun body, and the valve cartridge including a fluid inlet disposed outside of the gun bore.

The paint spray gun of the preceding paragraph can optionally include, additionally and/or alternatively, any one or more of the following features, configurations and/or additional components:

The interface is an anti-rotation interface that prevents rotation of the valve cartridge on the gun axis and relative to the gun body.

The anti-rotation interface is configured such that the valve cartridge can mount to the gun body with the fluid inlet in a plurality of orientations about the gun axis.

The plurality of orientations includes a vertical orientation and a lateral orientation.

The valve cartridge extends partially through the gun bore.

The valve cartridge includes a needle configured to move along the gun axis to cause a valve of the valve cartridge to move between an open state and a closed state.

The needle extends fully through a front end of the gun body, spans a void, and into a back end of the gun body.

A spring interface end of the needle interfaces with a spring assembly such that a spring of the spring assembly biases the needle towards a closed position associated with the closed state.

The spring assembly is mounted to the back end of the gun body.

The spring assembly includes the spring at least partially within a spring housing interfacing with the gun body.

The gun bore is formed by a mount bore extending fully through the front end and a spring bore extending into the back end.

The spring bore extends fully through the back end.

The valve cartridge includes a cartridge body, the cartridge body comprising an axial projection extending into the gun bore.

The cartridge body is sized such that a majority of an axial length of the cartridge body is disposed outside of the gun bore.

The valve cartridge does not include a spring within the cartridge body.

The valve cartridge is mountable to and dismountable from the gun body without fluidly disconnecting a fluid supply from the valve cartridge.

A valve cartridge for a paint spray gun, the valve cartridge includes a cartridge body including an outlet end having a cartridge outlet therethrough, a mount end, and a cartridge lock shaped to interface with a gun body of the paint spray gun to prevent rotation of the of the cartridge body about the valve axis and relative to the gun body. A fluid inlet extending through the cartridge body from an exterior of the cartridge body to a fluid chamber formed within the cartridge body, the fluid inlet disposed between the cartridge outlet and the cartridge lock and a valve disposed within the cartridge body and configured to control flow of the paint from the fluid chamber through the cartridge outlet.

The valve cartridge of the preceding paragraph can optionally include, additionally and/or alternatively, any one or more of the following features, configurations and/or additional components:

A needle partially disposed within the cartridge body and extending out of the cartridge body through the mount end, the needle movable along a valve axis to actuate the valve between an open state and a closed state.

A valve cartridge for a paint spray gun, the valve cartridge including a cartridge body including an outlet end having a cartridge outlet therethrough, a mount end, and a cartridge lock shaped to interface with a gun body of the paint spray gun to prevent rotation of the of the cartridge body about the valve axis and relative to the gun body. The cartridge body further includes a mount lock shaped to interface with an axial retainer to prevent axial displacement of the cartridge body relative to the gun body and a fluid inlet extending through the cartridge body from an exterior of the cartridge body to a fluid chamber formed within the cartridge body, the fluid inlet disposed between the cartridge outlet and the cartridge lock. The mount lock and the cartridge lock disposed on an opposite axial side of the fluid inlet from the cartridge outlet and a valve disposed within the cartridge body and configured to control flow of the paint from the fluid chamber through the cartridge outlet.

The valve cartridge of the preceding paragraph can optionally include, additionally and/or alternatively, any one or more of the following features, configurations and/or additional components:

The mount lock includes threading formed on the cartridge body.

The cartridge lock includes a contoured surface configured to interface with a receiver formed on the gun body of the paint spray gun.

A valve cartridge for a paint spray gun, the valve cartridge includes a cartridge body including an outlet end having a cartridge outlet therethrough, a mount end, and a fluid inlet extending through the cartridge body from an exterior of the cartridge body to a fluid chamber formed within the cartridge body, the fluid inlet disposed between the cartridge outlet and the cartridge lock. A valve disposed within the cartridge body and configured to control flow of the paint from the fluid chamber through the cartridge outlet and the valve cartridge does not include a spring within a fluid flowpath through the cartridge body between the fluid inlet and the cartridge outlet.

A valve cartridge for a paint spray gun, the valve cartridge includes a cartridge body includes an outlet end having a cartridge outlet therethrough, a mount end, and a fluid inlet extending through the cartridge body from an exterior of the cartridge body to a fluid chamber formed within the cartridge body, the fluid inlet disposed between the cartridge outlet and the cartridge lock. A valve disposed within the cartridge body and configured to control flow of the paint from the fluid chamber through the cartridge outlet and the valve cartridge does not include a spring.

The valve cartridge of the preceding paragraph can optionally include, additionally and/or alternatively, any one or more of the following features, configurations and/or additional components:

A needle that extends out of the cartridge body through the mount end.

A method assembling a sprayer for spraying, the method includes shifting a valve cartridge in a first axial direction along a bore axis of a gun bore of a gun body to interface the valve cartridge with the gun body, the valve cartridge disposed on the gun body such that a fluid inlet of the valve cartridge is not disposed within the gun body and locking the valve cartridge to the gun body to axially retain the valve cartridge on the gun body.

The method of the preceding paragraph can optionally include, additionally and/or alternatively, any one or more of the following features, configurations and/or additional components:

Locking the valve cartridge to the gun body to axially retain the valve cartridge on the gun body includes engaging a threaded interface between the gun body and the valve cartridge.

Engaging a threaded interface between the gun body and the valve cartridge includes engaging a threaded ring supported by the gun body with exterior threading formed on a cartridge body of the valve cartridge.

Shifting the valve cartridge in the first axial direction along the bore axis of the gun bore of the gun body to interface the valve cartridge with the gun body includes engaging a rotation lock between the valve cartridge and the gun body such that the valve cartridge is prevented from rotating on the bore axis.

Engaging the rotation lock between the valve cartridge and the gun body such that the valve cartridge is prevented from rotating on the bore axis includes inserting a projection into a receiver to engage the rotation lock.

Inserting the projection into the receiver to engage the rotation lock includes shifting the projection in the first axial direction with the valve cartridge such that the projection extends into the receiver formed in the gun body.

Shifting the projection in the first axial direction with the valve cartridge such that the projection extends into the receiver formed in the gun body includes aligning the projection with the gun bore on the bore axis and shifting the projection in the first axial direction with the valve cartridge such that the projection extends into the gun bore to interface with the receiver that is formed in the gun bore.

Unlocking the valve cartridge from the gun body and shifting the valve cartridge in a second axial direction opposite the first axial direction such that the valve cartridge disengages from the gun body and is dismounted from the gun body.

Unlocking the valve cartridge from the gun body does not include accessing the valve cartridge through a back end of the gun body.

Unlocking the valve cartridge from the gun body from the gun body includes disengaging a trigger from a needle of the valve cartridge.

Shifting the valve cartridge in the second axial direction opposite the first axial direction such that the valve cartridge disengages from the gun body and is dismounted from the gun body includes shifting the valve cartridge in the second axial direction prior to disconnecting a fluid supply from the valve cartridge.

Actuating a valve of the valve cartridge to an open state to cause spraying by the spray gun by applying a first displacing force on a needle of the valve cartridge at a first location disposed outside of a fluid path through the valve cartridge.

Actuating the valve of the valve cartridge to a closed state to stop spraying by the spray gun by applying a second displacing force on the needle at a second location disposed outside of the fluid path.

Actuating a valve of the valve cartridge to a closed state to stop spraying by the spray gun by applying a displacing force on a needle of the valve cartridge at a location disposed outside of a fluid path through the valve cartridge, by a spring disposed outside of the fluid path.

A needle for a valve of a sprayer, the needle includes a stem elongate along an axis, the stem includes an elongate body, a ball mount disposed at a first axial end of the elongate body, the ball mount formed integrally with the elongate body, and the ball mount having a first radial width and the elongate body having a second radial width. The first radial width larger than the second radial width and a ball mounted on the ball mount.

The needle of the preceding paragraph can optionally include, additionally and/or alternatively, any one or more of the following features, configurations and/or additional components:

A valve transition formed on the stem and transitioning between the first radial width and the second radial width, the valve transition extending both axially and radially.

A needle for a valve of a sprayer, the needle includes a stem elongate along an axis between a first axial end and a second axial end, the stem including an elongate body, a tail mount formed at the second axial end, a tail transition formed between the elongate body and tail mount, and the elongate body having a first radial width and the rail mount having a second radial width, the first radial width larger than the second radial width. A needle tail mounted on the stem, the needle tail connected to the tail mount at a threaded interface and interfacing with the tail transition and a ball mounted at the first axial end.

The needle of the preceding paragraph can optionally include, additionally and/or alternatively, any one or more of the following features, configurations and/or additional components:

The tail transition is extends both axially and radially.

The tail transition has a sloped exterior surface.

A spray assembly includes a first housing; and a second housing having a fluid fitting connected thereto, the second housing mountable to the first housing in a plurality of orientations such that the fluid fitting extends outwards in multiple directions relative to the first housing.

The spray assembly of the preceding paragraph can optionally include, additionally and/or alternatively, any one or more of the following features, configurations and/or additional components:

The multiple directions include at least two of up, down, left, and right.

The multiple directions include down and at least one of left and right.

The first housing is a gun body.

The second housing mounts to the gun body by an anti-rotation interface preventing rotation of the second housing relative to the first housing on a spray axis of the spray assembly and by an axial retention interface preventing axial movement of the second housing relative to the first housing along the spray axis.

The axial retention interface is formed by a threaded interface.

The anti-rotation interface is formed by a projection of the second housing extending into a receiver of the first housing.

The projection is disposed on the spray axis.

A method of forming a spray assembly for spraying a spray fluid onto a substrate includes mounting a second housing on a first housing such that a fluid fitting extending from the second housing is oriented in a first direction relative to the first housing; dismounting the second housing from the first housing; reorienting the second housing such that the fluid fitting extends in second direction relative to the first housing, the second direction different from the first direction; and mounting the second housing on the first housing such that the fluid fitting is oriented in the second direction.

The method of the preceding paragraph can optionally include, additionally and/or alternatively, any one or more of the following features, configurations and/or additional components:

Engaging an anti-rotation interface between the second housing and the first housing, the anti-rotation interface preventing rotation of the second housing relative to the first housing on a spray axis of the spray assembly; and engaging an axial retention interface between the second housing and the first housing, the axial retention interface preventing axial movement of the second housing relative to the first housing along the spray axis.

Shifting the second housing axially along a bore axis of a mount bore of the first housing.

Actuating a trigger supported by the first housing to cause spraying by the spray assembly with the fluid fitting oriented in the first direction.

Actuating the trigger supported by the first housing to cause spraying by the spray assembly with the fluid fitting oriented in the second direction.

A method of forming a spray assembly for spraying a spray fluid onto a substrate includes mounting a second housing on a first housing such that a fluid fitting extending from the second housing is oriented in a first direction relative to the first housing; spraying the spray fluid with the fluid fitting extending in the first direction; mounting the second housing on the first housing such that the fluid fitting is oriented in a second direction relative to the first housing, the second direction different from the first direction; and spraying the spray fluid with the fluid fitting extending in the second direction.

The method of the preceding paragraph can optionally include, additionally and/or alternatively, any one or more of the following features, configurations and/or additional components:

The first direction is one of up, down, left, and right; and the second direction is one of up, down, left, and right.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A paint spray gun, comprising:
a gun body;
a valve cartridge removably secured to the gun body; and
a trigger attached to the gun body and structured to actuate the valve cartridge;
wherein the gun body interfaces with the valve cartridge at an anti-rotation interface that prevents rotation of the valve cartridge when attached to the gun body.

2. The paint spray gun of claim 1, further comprising:
at least one engagement member formed on at least one of the gun body and the valve cartridge, the at least one engagement member forming at least a portion of the anti-rotation interface.

3. The paint spray gun of claim 1, wherein:
the anti-rotation interface is formed by a projection extending into a receiver.

4. The paint spray gun of claim 3, wherein the projection is aligned with a spray axis of the spray gun.

5. The paint spray gun of claim 3, wherein the projection is radially offset from a spray axis of the spray gun.

6. (canceled)

7. The paint spray gun of claim 3, wherein the valve cartridge includes the projection, the gun body includes the receiver, and the projection is configured to mate with the receiver at multiple relative positions.

8. The paint spray gun of claim 7, wherein the valve cartridge is configured to output spray fluid at an outlet end of a cartridge body of the valve cartridge and the projection is disposed at a mount end of the cartridge body, the mount end opposite the outlet end.

9. The paint spray gun of claim 8, wherein the valve cartridge includes a needle partially within the cartridge body and partially outside of the cartridge body, the needle configured to control flow of the spray fluid downstream from the valve cartridge, the needle extending through the projection.

10. The paint spray gun of claim 8, wherein the projection includes a plurality of flat surfaces and the recess includes a plurality of flat surfaces configured to interface with the plurality of flat surfaces of the projection to prevent relative rotation between the valve cartridge and the gun body.

11. The paint spray gun of claim 7, wherein the multiple relative positions includes at least two relative positions.

12.-13. (canceled)

14. The paint spray gun of claim 11, wherein the multiple relative positions includes a first position in which an inlet fitting of the valve cartridge projects vertically relative to the gun body and a second position in which the inlet fitting projects laterally relative to the gun body.

15. The paint spray gun of claim 1, wherein the valve cartridge comprises:
a cartridge body interfacing with the gun body at the anti-rotation interface; and
a needle partially disposed within the cartridge body and partially disposed outside of the cartridge body;
wherein a fluid inlet of the cartridge body is disposed outside of a gun bore within the gun body.

16. The paint spray gun of claim 15, wherein the valve cartridge further comprises:
an inlet fitting connected to the cartridge body and projecting outward from the cartridge body.

17. The paint spray gun of claim 16, wherein the inlet fitting is connected to the fluid inlet of the cartridge body.

18. The paint spray gun of claim 15, wherein the needle interfaces with a spring assembly supported by the gun body and the needle interfaces with a trigger supported by the gun body with the valve cartridge mounted on gun body.

19. The paint spray gun of claim 18, wherein the needle interfaces with the spring assembly such that the spring assembly biases the needle in a first axial direction along the valve axis to close a valve of the valve cartridge.

20. The paint spray gun of claim 1, wherein no spring is disposed within a fluid flowpath of the valve cartridge.

21. The paint spray gun of claim 1, wherein the gun body does not include a spray fluid pathway within the gun body.

22. (canceled)

23. A paint spray gun comprising:
a gun body having a gun bore formed therein; and
a valve cartridge mountable to and dismountable from the gun body, the valve cartridge configured to connect to a hose supplying spray fluid to the paint spray gun, the valve cartridge including a valve within the valve cartridge, the valve configured to be actuated between an open state and a closed state;
wherein the valve cartridge is at least partially disposed within the gun body; and
wherein a fluid inlet of the valve cartridge is disposed outside of the gun body with the valve cartridge mounted to the gun body.

24.-95. (canceled)

96. A paint spray gun comprising:
a gun body supporting a trigger;
a gun bore extending at least partially through the gun body;
a valve cartridge configured to interface with the gun body by axial movement of the valve cartridge along the gun axis, the valve cartridge interfacing with the gun body such that the valve cartridge can support or be supported by the gun body; and
the valve cartridge including a fluid inlet disposed outside of the gun bore.

97.-153. (canceled)
